(19) United States
(12) Patent Application Publication
(10) Pub. No.: US 2004/0117315 A1
(43) Pub. Date: Jun. 17, 2004

(54) Online transaction information backup method and device

(76) Inventor: George Cornuejols, Paris (FR)

Correspondence Address: YOUNG & THOMPSON, 745 SOUTH 23RD STREET 2ND FLOOR, ARLINGTON, VA, 22202

(21) Appl. No.: 10/362,935

(22) PCT Filed: Aug. 30, 2001
(86) PCT No.: PCT/FR01/02705

(30) Foreign Application Priority Data
Aug. 30, 2000 (WO) PCT/IB00/01312

(51) Int. Cl. G06F 17/60

(52) U.S. Cl. 705/64

(57) ABSTRACT

The online transaction information backup method includes:

1) a step of detecting a start of a visit of a remote site,

2) a step of detecting a transaction including at least one of the following steps:

a) a step of detecting an implementation of an authentication method or an asymmetric keys electronic signature of the user,

b) a step of detecting at least one predetermined symbol sequence in a page received from the site and

c) a step of determining that a page address or a domain name of the remote site corresponds to at least one predetermined address;

3) and when a transaction is detected, a step of storing in permanent memory a trace of pages of said remote site.

The present invention deals with an online transaction information backup method and an online transaction information backup device. It applies in particular to transactions conducted through a computer network such as, for instance, internet.

The user of a communication network, internet for instance, feels somewhat uncomfortable when using this network. He is unable to keep organized records of the computer pages he receives, of the commitments of the merchant's site, of the laws applying to the transaction and finally he feels insecure when buying on line.

The users of such a network are badly protected against abuses from third parties, and particularly from websites, commercial sites or administrative sites.

The present invention aims at remedying these inconveniences.

A first aspect of this invention concerns a transaction information backup method including:

a step of detecting a start of a visit of a remote site,

a step of detecting a transaction including at least one of the following steps:

a step of detecting an implementation of an authentication method or an electronic signature of the user using asymmetric keys,

a step of detecting at least one predetermined symbol sequence in a page received from the site and

a step of determining that a page address or a domain name of the remote site corresponds to at least one predetermined address,

and, when a transaction is detected, a step of storing in a permanent memory a trace of pages of said remote site.

Thanks to these features, the visit of a remote site is detected and, when a transaction implying an authentication or an electronic signature with asymmetric keys, or a site page indicating that a transaction is being conducted either by its content or by its address, the automatic backup of the site pages allows the user to later refer to that trace in case of a problem relating to that transaction.

One notices that the authentication or signatures are, in accordance with the present invention, with asymmetric keys, for e.g. complying with the public key infrastructure (PKI) The present invention does not apply to authentication by biometrical measures, by microchips or confidential code. As a matter of fact, this last types of authentication are not complying with the laws about electronic signature and therefore are not legally binding an online buyer (they are generally limited to granting access to the terminal of the user or to a customer account on a site and do not allow to conduct a transaction). Moreover, technically, the use of asymmetric keys allows the site to immediately check the identity of the contracting party or the declaring party by using a so called “public key”, generally available on line.

According to particular features, i.e. in variants or exemplary embodiments, after the step of detecting a start of a visit, a step of setting up the trace begins before the detection of a transaction, and when no transaction is detected, the trace is automatically deleted.

One notices that deleting this trace may be performed either immediately when detecting an exit from said site or later, for instance, after a predetermined amount of time or in accordance with a memory space available to store traces of visits and/or transactions.

According to particular features, the method as briefly presented above includes a step of detecting an end of transaction, by detecting an exit from the visited site and of predetermined sites linked to the visited site. The linked sites may be, for instance, payment sites or sites accessible by a link in the visited site, these sites or certain pages of these sites being, for instance, referred to in a database in relation with the visited site. Thanks to these features, not only the beginning but also the end of the transaction are automatically determined.

According to particular features, the step of determining that a page address or a domain name of the remote site corresponds to at least one predetermined address includes a step of detecting that an address root corresponds to an encrypted communication mode. In fact, the inventor has discovered that this communication mode generally indicates a transaction.

According to particular features, the step of determining that a page address or a domain name of the remote site corresponds to at least one predetermined address includes a step of detecting that said address or this remote site domain name corresponds to a symbol sequence stored in a database.

According to particular features, the step of determining that a page address or a domain name of the remote site corresponds to at least one predetermined address includes a step of determining that the remote site is listed in a database and:

if the remote site is listed in the database, a step of determining that a page address or a domain name of the visited site corresponds to at least one page address or a domain name stored in said database in relation with an identifier of said remote site and

if the remote site is not listed in the database, a step of determining that an encrypted communication mode is used and/or that the visit of a page of another site different from the remote site corresponds to a predetermined transaction site.

Thanks to each of these features, the transaction detection implementation is simple and efficient even for sites unknown of the database. For instance, the predetermined transaction site is a payment site accessible from many commercial or administrative sites.

According to particular features, the step of detecting a start of a visit includes a step of determining a visited page address and at least one of the following steps:

a step of determining that this address corresponds to a page of a site different from the previously visited site and

a step of comparing said address with addresses stored in a database.

Thanks to these features, when a user gains access to a new remote site independent from the site that he was already visiting, the detection of the start of the new site visit is determined by processing said page address. This way it is not necessary that the site issues specific information for the detection of the start of the visit.

According to particular features, during the step of storing in a permanent memory, the visited pages trace is representative of all the pages of the remote site that have been visited from the detection of the visit start. Consequently, the stored trace concerns all the visited pages and not only certain page in such a way that it is a highly representing the transaction. According to particular features, the method includes a step of selecting, by the user, whether or not to store the traces of all visits on at least one predetermined site and when no transaction is detected, the step of storing in a permanent memory is performed only if, for the remote site concerned, the user has decided that a trace should be stored, during the step of selecting. Thanks to each of these features, no memory is occupied by useless visits traces.

According to particular features, the method includes, when a transaction is detected, a step of making contextual information related to said remote site available to the user. According to particular features, when a step of storing in a permanent memory a trace of pages visited in said remote site is performed, a trace of at least one predetermined page of said remote site is stored, even if said predetermined page has not been visited. Thanks to these features, whenever a transaction has been detected, information complementing the information of the pages he has visited is available to the user, in the stored trace.

According to particular features, whenever an authentication or an asymmetric keys electronic signature is performed, during a step of editing, at least one portion of page of said remote site is selected by the signer and incorporated into the signed document. According to particular features, during a communication step, information representing the incorporated pages or portions of pages is sent to said remote site. Thanks to each of these features, the user may include in an order form or a signed statement, the elements on which he has based his decision to sign, for example a picture of an object, general sales conditions, an administrative note or specifications of a product or service.

According to particular features, during said step of storing in a permanent memory, and for at least one predetermined remote site, a trace of pages of a previously visited site is stored. This way, if the predetermined site on which a detection of a transaction is performed corresponds to a payment or electronic signature provider, a trace of the site from which the user reaches this predetermined site is stored.

According to particular features, during the step of storing in a permanent memory, said trace of visited pages includes information on which portions of said pages have been displayed to a user. According to particular features, during the step of storing in a permanent memory, said trace of visited pages represents only portions of pages that have been displayed. Thanks to each of these features, said trace stored in memory certifies the information upon which the user has agreed to perform a transaction.

According to particular features, said step of storing in a permanent memory includes a step of compressing images displayed on a screen accessible to a user. According to particular features, said step of compressing images includes a step of limiting the number of colours rendered and a step of compressing without loss images resulting from the step of limiting the number of colours rendered. Thanks to these features, the stored trace is reduced in size.

According to particular features, said step of storing is performed on the information transmission link between said remote site and the user independently from said remote site. Thanks to these features, the remote site is not involved in the storage of said trace which is performed, for instance, on a terminal by means of which the user gains access to the remote site, on a internet service provider's server or on a portal through which the user gains access to said remote site. These features allow for the creation of notarization services on the information transmission link in question.

According to particular features, all said steps of said method are performed on a user terminal. Thanks to these features, the implementation of said method is easy since it is independent from the remote site. Moreover, the user keeps the control of the implementation of said method.

According to particular features, the step of storing in a permanent memory includes a step of transmitting said trace or an integrity certificate of said trace (for instance a hash value, a redundancy code or a check sum) to a remote memory. Thanks to these features, said trace may be stored by the user in a chosen place.

According to particular features, the method as briefly described above includes a step of transmitting to said remote site a predetermined signal representative of the implementation of said method. Thanks to each of these features, the user on the one hand and the remote site on the other hand may benefit from the implementation of the method, purpose of the present invention.

According to particular features, the method, as briefly described above, includes a step of receiving information representative of pages of the remote site in question and, during the step of storing in a permanent memory, a trace of the content of said pages is stored in memory. One notices that the representative information may include at least one page address of the remote site and/or a representation of the content of said page, for instance. According to particular features, the step of storing in a permanent memory includes a step of receiving information coming from a third party independent from said remote site. Thanks to each of these features, said trace may be authenticated. One notices that information transmitted to a third party site or received from it may include at least one of: a transaction number, a software license number, a date, an hour, information representative of said remote site, a trace for instance determined by a function known as “hash” or an error correction code or a redundancy code, each corresponding to at least one portion of the stored trace.

According to particular features, the method as briefly described above includes a step of determining an active window corresponding to a browser software. Preferably, said trace is not representative of any activity performed when no active window corresponds to a browser software. Thanks to each of these features, when a user keeps, in background, inactive way, a browser software window opened, the trace is not representative of the activities performed by said user, for instance, if the trace is generated by means of image compression.

According to particular features, the method as briefly described above includes a step of downloading or updating, at least partially, a database. According to particular features, said database includes addresses used in said step of detecting a transaction. According to particular features, said database includes domain names. According to particular features, said step of updating is performed each time a transaction is detected. According to particular features, a step of partially updating the database is performed each time a visit start takes place. According to particular features, said updating is not performed if the visited site has been visited during a previous predetermined period of time. Thanks to these features, at least one of the steps performed according to said method is performed in relation with said database.

According to particular features, said method includes a step of downloading a software designed to implement the other steps of said method and a step of installing said software during which a trace is remotely sent to determine if said software works properly. Thanks to these features, the good working order of said software is automatically determined.

According to particular features, the step of detecting a transaction and/or the step of detecting a visit start is performed only for certain predetermined remote sites. Thanks to these features, said remote sites can provide their visitors with a security level increased as compared to the other remote sites.

According to particular features, said trace is encrypted. Thanks to these features, the confidential character of the information included in or represented by said trace is guaranted.

According to particular features, during the step of detecting a transaction, a means of payment is associated with each transaction and, during a step of spendings recap, a total amount of the spendings with at least one means of payment is determined. According to particular features, during said step of spendings recap, a start date and an end date of the recap are used and the total amount concerns only the transactions performed between the two dates with said payment means.

According to particular features, the method as briefly described above includes a step of determining a memory space available for new traces. According to particular features, when said memory space is less than a predetermined memory space, a step of displaying information relating to the management of said memory or a step of trace deletion is performed. For example, are deleted in that order the traces not relating to a transaction, then the oldest trace of transaction on predetermined sites, for example a transaction of information provision.

A second aspect of the present invention concerns a transaction information backup method including:

a step of detecting a start of a visit of a remote site,

a step of authenticating or electronically signing using user's asymmetric keys,

a step of editing during which at least a portion of a page of said remote site is selected by the signer and incorporated into a signed document and

a step of storing in a permanent memory a trace of signed pages of said remote site.

Thanks to these features, the user can amend the document submitted to his signature to include elements of the remote site offers that he considers essential to his consent to sign.

According to particular features, during a step of communicating with said remote site, information representing said incorporated pages or portions of pages is sent to the remote site.

Thanks to each of these features, the user can incorporate into an order or into a signed statement, the elements on which the user has based his decision of signing, for example a picture of an object, general sales conditions, an administrative note specifications about a product or a service.

A third aspect of the present invention concerns a transaction information backup device including:

a detection means that detects a start of a visit of a remote site,

a transaction detection means that performs at least one of the following steps:

a step of detecting an implementation of an authentication method or an electronic signature of the user using asymmetric keys,

a step of detecting at least one predetermined symbol sequence in a page received from the site and

a step of determining that a page address or a domain name of the remote site corresponds to at least one predetermined address,

and a storing means that stores in a permanent memory a trace of pages of said site when a transaction is detected.

A fourth aspect of the present invention concerns a storing device of transaction information including:

a detection means that detects a start of a visit of a remote site,

an authentication means that authenticates or electronically signs with asymmetric keys of the user,

an edition means that edits at least one portion of a page of said remote site selected by the signer, said edition means incorporating each selected page portion into a signed document and

a storing means that stores in a permanent memory a trace of pages of said remote site.

The particular features and advantages of the second, third and fourth aspects of the present invention are identical to those of the first aspect. Consequently they are not repeated here.

Other advantages, aims and feature of the present invention will be brought out by the followings description given for explanation and not at all limitation facing the enclosed drawings in which:

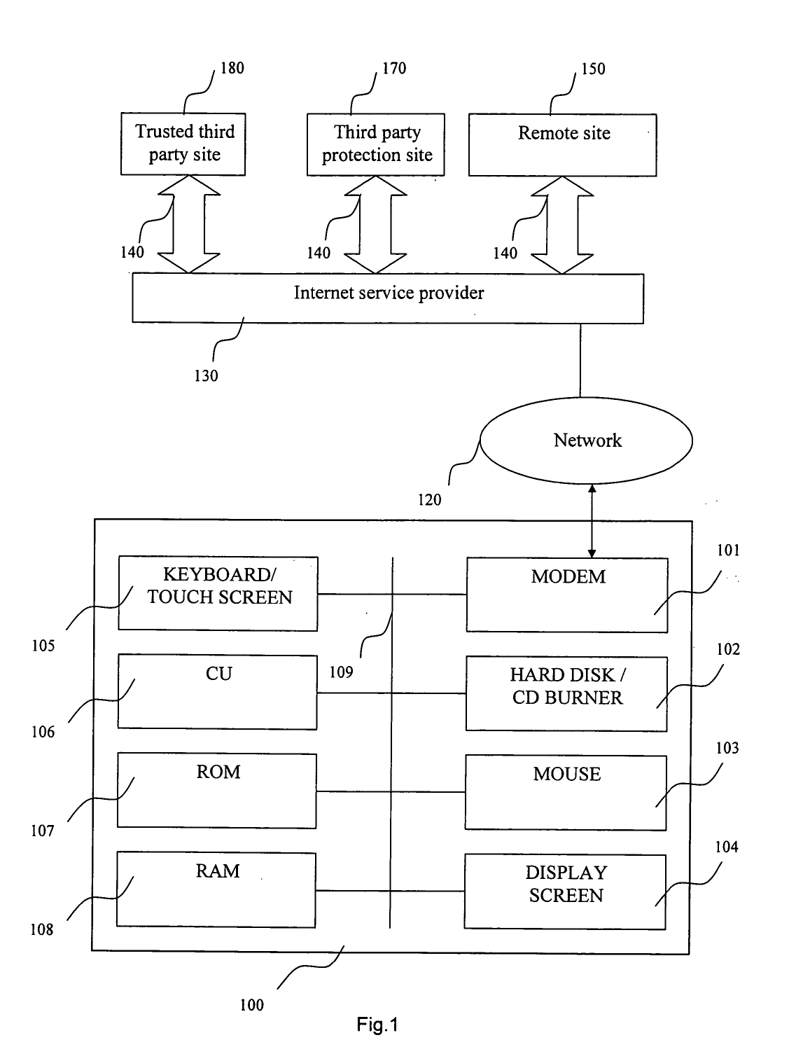

FIG. 1 represents a device, communicating with a computerized network, adapted to the implementation of at least one exemplary embodiment of the present invention;

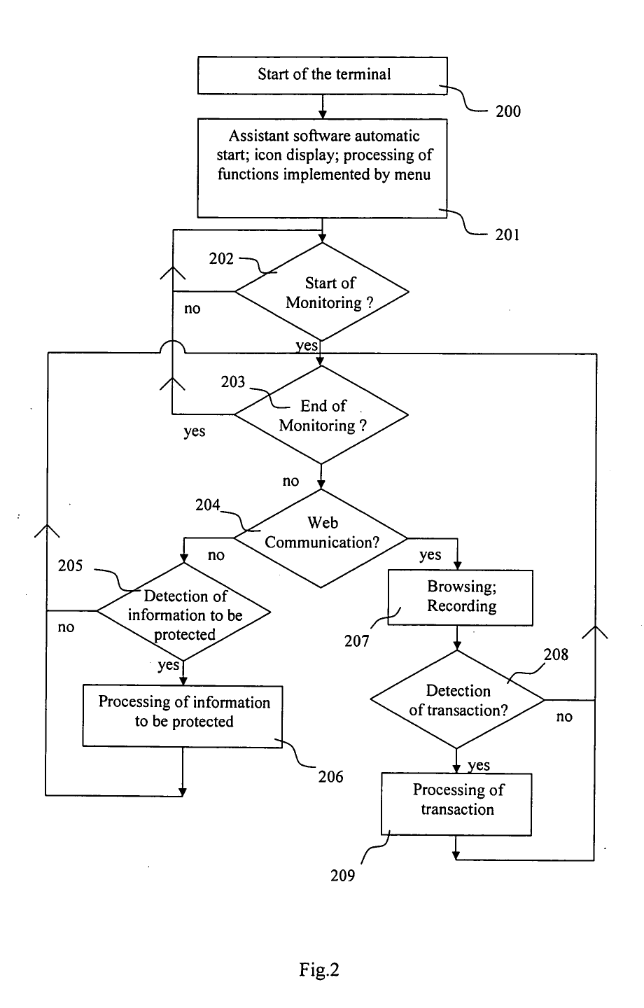

FIG. 2 shows an organigram of steps performed in an exemplary embodiment of the present invention, for example in relation with the embodiment of the device shown in FIG. 1;

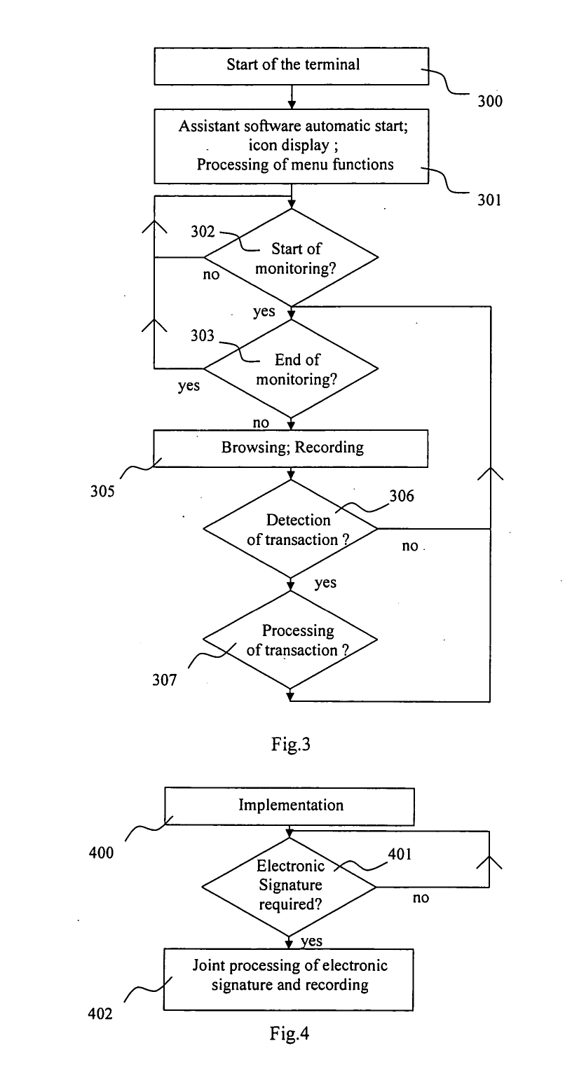

FIG. 3 shows an organigram of steps performed in an exemplary embodiment of the present invention, for example in relation with the embodiment of the device shown in FIG. 1;

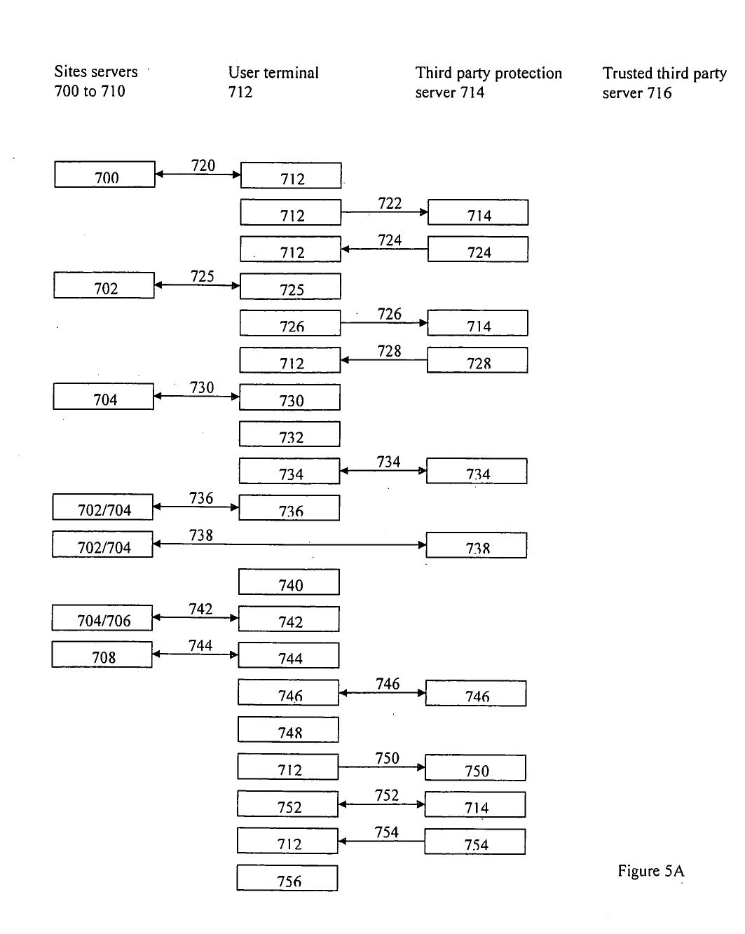

FIG. 4 shows an organigram of steps performed in an exemplary embodiment of the present invention, for example in relation with the embodiment of the device shown in FIG. 1;

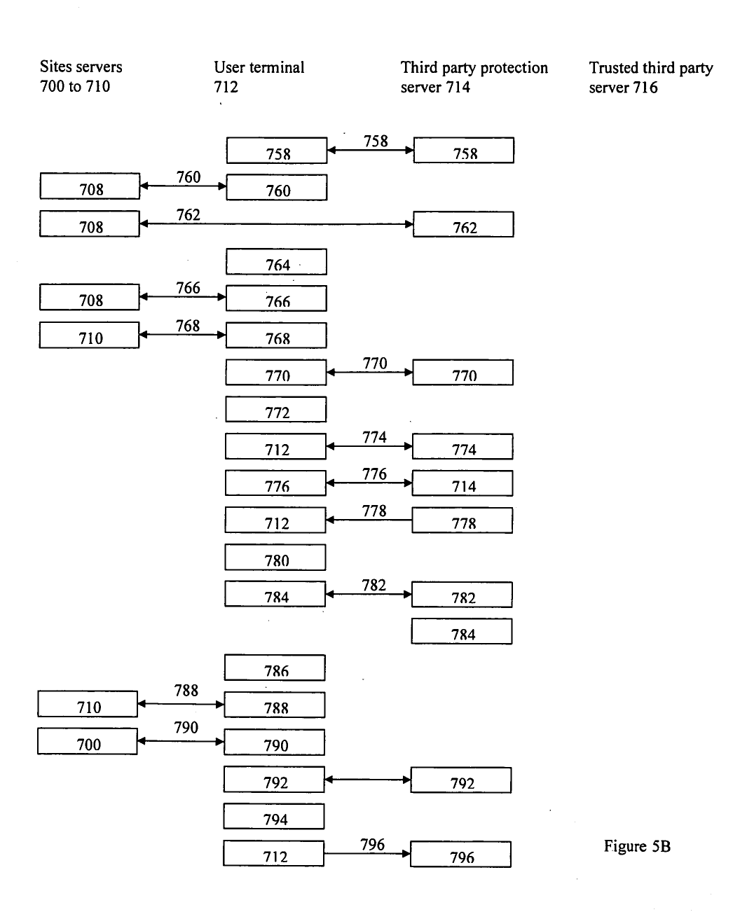

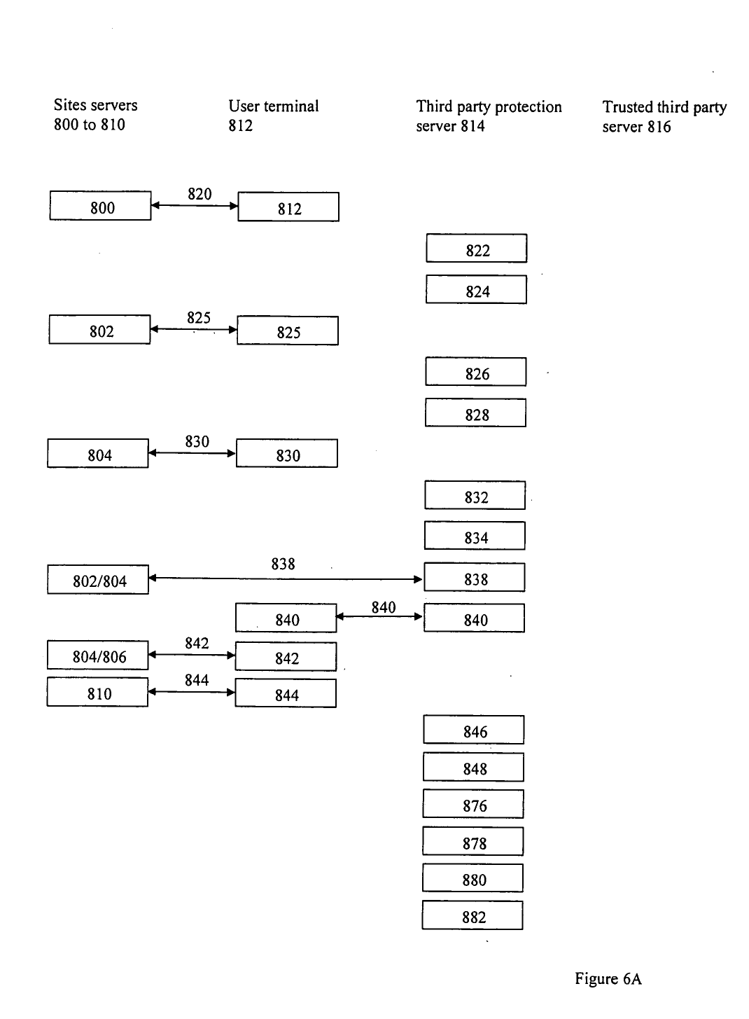

FIGS. 5A to 6B show communications and steps implemented in two exemplary embodiments of the present invention, for example in relation with the embodiment of the device shown in FIG. 1 and

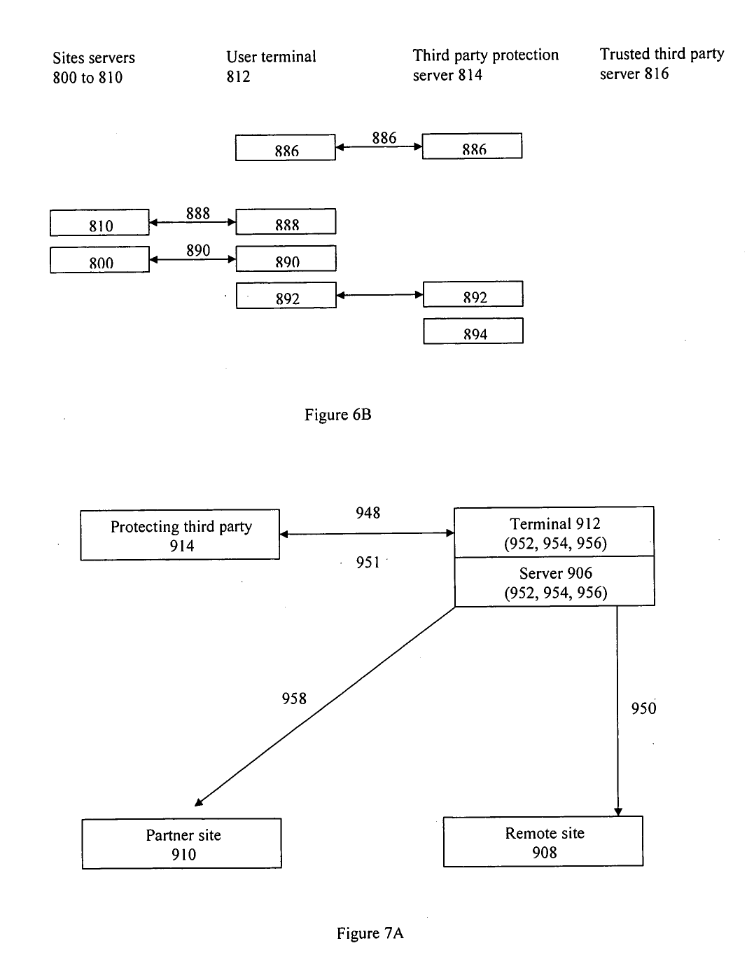

FIGS. 7A and 7B represent, under the form of a relational chart and organigram, another aspect of the present invention.

In all the description the terms “trace”, “recording”, “digital contract” or “transaction file” refer indifferently to data representing the visit of a site and then if a transaction or preparation of a transaction is detected, to their backup in a permanent memory. In all the description, the word “user” refers to a person who visits a site and/or conducts a transaction or an administrative declaration. In all the description the expressions “transaction detection” and “transaction preparation detection” are equivalent, for example when a user selects a product or a service and fills up a cart on a site, he prepares a transaction that might not take place or be finalized later by the payment of the product or service. However, legally speaking, the transaction preparation involves commitments of the site, in particular the presentation of the product or service which motivates the selection by the user and the assistance software performs the same procedure as if the transaction had been finalized. Similarly, when the user transmits to the site “information to be protected” (i.e. confidential or sensitive information) this implies obligations for the site, would it be only to respect the privacy of the user and thus a transaction is performed by simply transmitting the information to be protected. For the same reasons the term “transaction” covers the administrative declaration because they involve commitments of the declaration site.

In all the description, the terms “computer” when it concerns equipment operated by the user, is equivalent to the terms “terminal” or “user terminal” and these expressions are employed indifferently.

For certain aspects of the present invention, preferentially, the method is implemented in background so as not to disturb the operation habits of the user, at least until an online transaction is detected. According to exemplary variants of these aspects, the method interacts with the user only when a transaction is performed (except the possible display of an icon in a toolbar or within the functions of a browser) and when a transaction is performed, a dialog window is opened when the transaction is detected and/or at the end of the transaction. According to exemplary variants of these aspects, the method does not interact with the user even when a transaction is detected.

For each of these aspects of the present invention, at least one portion of software which implements it is preferably located in the user's terminal or in a concerned internet service provider's server or in a server of a portal's giving access to some functions of this network.

Each of the aspects of the present invention is involved in the definition of a method and/or a device for assisting the user of a communication network. In the following description, the term “assistance software” refers to exemplary embodiments implementing certain aspects of the method and/or the device concerned by the present invention.

FIG. 1 represents a user terminal computer 100 connected to a remote site 150, through a network 120, an internet service provider server 130 and a network 140.

In the first embodiment shown in FIG. 1, the terminal 100 includes, linked together by an address and data bus 109, a communication device on a network 101, a permanent storage device 102, a pointing device 103, a display screen 104, a keyboard (or touch screen) 105, a central unit 106, a permanent central memory 107 and a non permanent memory 108.

The network 120 is, for example, the phone network, a cable network (carrying out also, for example, TV signals) or a DSL line. The internet service provider server 130 is, for example, the server of an internet service provider known as AOL (registered trademark) or WANADOO (registered trademark). The network 140 is for example the computerized communication network known as internet. The remote site 150 is hosted by a computerized server programmed for that purpose by means of a known technical process.

In the exemplary embodiment shown in FIG. 1, terminal 100 is a personal computer known as PC or a network computer known as NC or a personal digital assistant known as PDA. The communication device on network 101 is, for example, a modulator demodulator or MODEM or a network card. The permanent storage device 102 is, for example, a hard disk, a reader/writer of compact discs or permanent memory components used in particular in personnal assistants. The pointing device 103 is, for example, a mouse or incorporated in the display screen 104 under the form of a tactile screen. The display screen 104 is, for example, a flat screen, a tactile screen or a cathod-ray tube screen.

The keyboard 105 is adapted to allow selection of alphanumeric characters. It can take the shape of a tactile screen associated to an optical character recognition device. The central unit 106 is, for example, a microprocessor or microcontroller, for example Intel (registered trademark) Pentium (registered trademark) or compatible. The permanent central memory 107 stores the instructions of the processor 106 that make it start when it is powered. The non permanent memory 108 is, for example, a cache memory adapted to store information representing at least one page received from a site such as the remote site 150.

For the implementation of certain aspects of the present invention, the terminal 100 is linked, through a network 140, to a third party assistance or protection site 170 and to a trusted third party site 180. The third party protection site 170 has a server which stores internet pages and/or a database that can be queried by terminal 100. The trusted third party site 180 has a database on which recordings or integrity certificate can be stored by terminal 100. As a variant, at least one of sites 170 and 180 is joined with provider site 130.

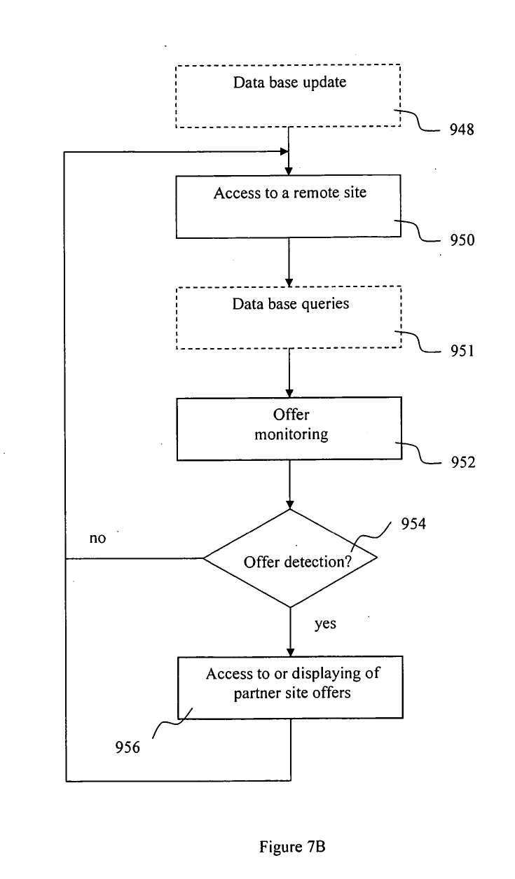

In exemplary embodiments, terminal 100, internet service provider 130, the third party protection site 170, or a combination of these means working together is adapted to implement one of the charts or a combination of charts shown in FIGS. 2 to 8 or presented below facing FIG. 1 or still the feature described in the preamble of the present application, preamble which is part of the description of exemplary embodiments of the present invention but is not represented here for better concision. Moreover, technically, the use of asymmetric keys allows the site to verify immediately the identity of the contracting party by the use of a public key generally available on line.

According to a first aspect of the invention, the terminal 100, internet service provider 130, the third party protection site 170 or a combination of these means working together, is adapted to perform:

a step of detecting a start of a visit of a remote site,

a step of detecting a transaction including at least one of the following steps:

a step of detecting an implementation of an authentication method or an electronic signature of the user using asymmetric keys,

a step of detecting at least one predetermined symbol sequence in a page received from the site and

a step of determining that a page address or a domain name of the remote site corresponds to at least one predetermined address,

and, when a transaction is detected, a step of storing in a permanent memory a trace of pages of said remote site.

According to a fifth aspect of the invention, the terminal 100, internet service provider 130, the third party protection site 170 or a combination of these means working together, is adapted to perform:

a step of detecting a start of a visit of a remote site,

a step of detecting a transaction including a step of detecting an implementation of an authentication method or an electronic signature of the user using asymmetric keys,

and, when a transaction is detected, a step of storing in a permanent memory a trace of pages of said remote site.

According to the first and fifth aspects of the present invention and more generally whenever the description refers to an authentication or an electronic signature used to detect a transaction, the authentication or signature are using asymmetric keys, for example in accordance with the public key infrastructure (PKI). The present invention does not concern authentication towards a user's terminal which would not implement the asymmetric keys, e.g. authentication by biometrical measures, by microchips or confidential keys. In fact, this last types of authentication are not complying with the laws or electronic signature and therefore are not legally online buyer (they are generally limited to access the terminal of the user or a customer account on a site and do not allow to perform a transaction).

According to a sixth aspect of the invention, the terminal 100, internet service provider 130, the third party protection site 170 or a combination of these means working together, is adapted to perform:

a step of detecting a start of a visit of a remote site,

a step of detecting a transaction including a step of detecting at least one predetermined symbol sequence in a page received from the site

and, when a transaction is detected, a step of storing in a permanent memory a trace of pages of said remote site.

The sequence of symbols detected in the page received from the remote site 150 may be found, according to two variants concerning problems that are different whether or not the site uses pages well differentiated for the different steps of a transaction or not found in its address or domain name or in content, e.g. described in one of the description languages HTML or XML. For example, the site nomatica.com uses one address for all its pages, the steps of a transaction being known by the implementation of JavaScript functions and the processing of the content of each page of this site to search keywords (such as “order”, “cart”, “payment”) or words referenced in the domain name of this site in a database accessible to terminal 100, enables the detection of a transaction. For the implementation of this means of transaction detection, the man of the art may either scan the information passing through a communication port of terminal 100, or related with the browser software, or use a reading routine of page description and search the keywords in this description.

To the contrary, a site like “amazon.com” uses different page names for all the different pages of the site and reading the page address allows to detect the preparation of a transaction (for example, the words “checkout”, “cart” and “one-click” correspond to different steps of a transaction and of the payment of a product or a service sold on this site). The registration in a database accessible to terminal 100, of this words or bigger portion of pages of amazon.com's site pages, facing the domain name “amazon.com” allows the detection of a transaction or of a transaction preparation.

According to a seventh aspect of the invention, the terminal 100, the provider 130, the third party provider site 170 or a combination of these means working together is adapted to perform:

a step of detecting a start of a visit of a remote site,

a step of detecting a transaction including a step of determining that a page address or a domain name of the remote site corresponds to at least one predetermined address,

and, when a transaction is detected, a step of storing in a permanent memory a trace of pages of said remote site.

According to each of the first, fifth, sixth and seventh aspects of the invention, the visit of a remote site is detected and when a transaction is detected, the storage of a trace of the pages visited on said site later allows the user to refer to this trace in case of a problem related to said transaction.

In exemplary embodiments, to generate said trace, from the step of detecting the start of the visit on, a step of generating said trace is performed and when said storage in a permanent memory doesn't take place, the generated trace is automatically deleted. For example, said trace is stored during the duration of the visit of one or two extra sites, and then deleted. According to another example, said trace is stored during a predetermined amount of time or in function of the memory space available for other traces, more recent or related to transactions.

For example, a database accessible to terminal 100 indicates relations between sites, in particular when a purchase can be continued from one of the sites, in which the customer chooses a good or a service that he wants, to another site, where he identifies himself and/or pays. In that case, the trace of the transaction may represent more than one site and the step of storing in a permanent memory may concern a trace that covers more than one site. For example, said trace is stored until a particular permanent memory space dedicated to the implementation of the method of the present invention is used, or until a particular remaing available memory space dedicated to the implementation of the method of the present invention is reached and, when a transaction is detected on the site being visited, the traces concerning that site stored in a permanent memory are proposed to the user as complement to the trace concerning the visited site. So, for sites in which a transaction can be performed in several visits (using a cart for instance), different traces related to visits concerning said transaction can be attached together, with the user's consent.

In exemplary embodiments, the method includes a detection of an end of transaction, using the detection of the end of the site visit and of sites linked to said visited site in a database accessible to terminal 100. The associate sites may be, for example, payment sites or sites accessed by a link on said visited site, these sites or certain pages of these sites being, for example, marked in the database as corresponding to said visited site.

In exemplary embodiments, determining that the page address of a remote site corresponds to at least one predetermined address includes detecting that an address root corresponds to an encrypted communication mode. For example, the root may be “https” for the encryption known as SSL, for Secure Socket Layer.

In exemplary embodiments, determining that a page address of a remote site corresponds to at least one predetermined address includes detecting that said address corresponds to an address stored in a database. For example, one portion of said address includes the symbol sequence “cart” on the site cdnow.com or the symbol sequence “one-click” on the site amazon.com. The database, which can be, for example, stored by the terminal 100, the third party protection site 170, or the visited site keeps, in relation with an identification of the site, these symbol sequences characterizing the preparation of a transaction.

In exemplary embodiments, determining that a page address or a remote site domain name corresponds to at least one predetermined address includes determining that this remote site is listed in a database accessible to terminal 100 and:

if the remote site is listed in the database, determining that a page address or a visited domain name corresponds to at least one page address or a domain name stored in said database in relation with an identifier of the remote site and

if the remote site is not listed in the database, determining the implementation of an encrypted communication mode and/or the visit of a page of a site different from said remote site corresponds to a predetermined transaction site.

For the implementation of certain of these exemplary embodiments, the database receives from terminal 100 a request identifying the remote site 150, for example, by its domain name, and return data different whether the site 150 is listed or not in this database.

When the remote site 150 is listed in this database, the database returns addresses or domain names indicating a transaction, for example, at least a page address to which the user gains access when he selects a good or service and/or he fills up the shopping cart, at least a page address or a domain name of a payment site, possibly independent of site 150 but on which the user can pay a product or service ordered on site 150. This portion of the database may be filled up by manual and visual inspection, or by a robot programmed to find out pages with keywords, on sites for which many requests are transmitted by terminals 100 implementing the assistance software. When the remote site is not listed, the database returns data representing at least one page of a site on which a transaction may be validated (by signature or asymmetric keys authentication or by payment) independent from site 150. For example, these data may include the domain names or the page addresses of all the payment sites of the database which are not listed sites and which correspond to the same country or the same region (determined by calling DNS servers) as the remote site 150, object of the request. For example, a transaction on the site nomatica.com listed in the database, enable to pay with a bank card on the site sogenal.fr and this domain name sogenal.fr is transmitted by the database with others domain names or page addresses of the same type, in answer to the request concerning the French or European remote sites not listed in the database.

It should be noted that, for the listed sites, the answer to the request from a terminal 100 may include the addresses or the domain names of sites on which a transaction started on the remote site 150 may be continued. For example, a transaction started on the site nomatica.com may continue on the site nomatica.fr and, as indicated above, on the site sogenal.fr. The assistance software then processes the transfer from remote site 150 to a site on which the transaction can be continued, as if those sites were but one remote site 150.

In exemplary embodiments, the step of detecting the visit start includes a step of determining a visit page address and at least one of the following steps:

a step of determining that this address corresponds to a page of a site different from the previously visited site and

a step of comparing said address with the addresses stored in the database (so as not to mistake for a transaction start, the transit on a site associated with the remote site 150 as indicated above).

This way, when a user gains access to a new site that he was not already visiting, the detection of the start of the visit of the new site is determined by processing the address of the accessed page. Then, it is not necessary that the site transmits specific information for the visit start to be detected.

In exemplary embodiments, during the storage in a permanent memory, the trace of visited pages represents all the pages of the remote site which have been visited since the step of detecting the visit start. This way, the stored trace concerns all the visited pages of the site and not only certain pages, in such a way that a trace allows determining all the pages to which the user has gain access before agreeing to contract.

In exemplary embodiments, when no transaction is detected, no site pages trace is stored in a permanent memory. In exemplary embodiments, when no transaction is detected, a site page trace is stored in a permanent memory and automatically deleted as a function of the permanent memory space which is available and/or allocated to the implementation of the invention method.

In exemplary embodiments, during the storage in a permanent memory, the trace of visited pages represents all the pages of the remote site which have been visited since the step of detecting the visit start. This way the stored trace concerns all the visited pages and not only certain pages, in such a way that it is highly representative of the transaction. In exemplary embodiments, the user decides to store or not the traces of all the visits on at least one predetermined site and when no transaction is detected the storage in a permanent memory is performed only if, for said remote site, the user has chosen that a trace should be stored, during said selection step. The selection step may be performed according to known interfacing techniques, for example, by displaying a dialog window proposing different options. Thanks to each of these features, no memory is cluttered by visit traces that the user considers as useless, for example, accesses to databases using an encrypted communication mode, where no transaction may occur, although permitting a user to store several successive traces concerning sites on which he trades stocks, for example, in such a way that if no confirmation of trades is sent back to the users, he nevertheless keeps a trace of it.

In exemplary embodiments, the method includes, when a transaction is detected, a step of providing the user with contextual information depending on said remote site. This contextual information may be related to the country of the site, to the laws applicable to a purchase on said site, to the qualities of the site, to advice specific to the site type (auction site, site for kids . . . ) and/or to services that can improve a purchasing experience on said site. For example, a database, stored in terminal 100 or remotely, receives from a user's terminal, information representing the context and returns the contextual information to be provided to the user, according to known databases requesting procedures.

In exemplary embodiments, when no transaction is detected, at least one portion of said contextual information is not made available to the user. This allows, in particular, to save bandwidth between storage locations of the contextual information, for example, network server and terminal 100.

In exemplary embodiments, when a storage in a permanent memory of a trace of pages visited on said site is performed, a trace of at least one predetermined page of said site is recorded, even if said predetermined page hasn't been visited. For example, a database stores the addresses of legal material pages of said site and when a storage in a permanent memory is performed, for example, when a transaction is detected, the database is queried by the terminal 100 and the pages which have the addresses in question are searched through a browser interface and automatically associated with said trace stored in a permanent memory.

Thanks to each of these features, when a transaction is detected, the user is provided with complementary information, either during the transaction or within the stored trace.

In exemplary embodiments, when an electronic signature using asymmetric keys is used, during a step of editing, pages or portions of pages of said remote 150 site are associated with the signed document, after asking the user or automatically. For that purpose, for example, a software that implements the electronic signature, e.g. memory card reader driver, calls a software which implements the method of the present invention. In exemplary embodiments, during a communication with said remote site, information representing said pages or portion of pages associated is transmitted to said remote site. A communication protocol with the site may be used for that purpose.

Thanks to these features, the user may include into the signed contract, the elements on which he has based his decisions to sign, e.g. a picture of an object he is buying, general sale conditions, product or service specifications.

In exemplary embodiments, during said storage in a permanent memory, a trace of previously visited site pages is also recorded. For example, the trace of the site whose visit comes immediately before the visit of the site which is visited by user is recorded according to predetermined criteria. For example, in a database, one of the sites is connected with the other. This way, if the visited site, on which a transaction is detected, corresponds to a company that receives payment or signature, a trace of the visited site from which the user has reached the site on which the transaction is detected is performed. For that purpose, a database stored remotely or in terminal 100 can be queried by known techniques. According to an another example, a trace of each visit is stored in a permanent memory and when a storage in a permanent memory is performed and a transaction is detected, the trace of the current visit and the trace of the previous visit of the same site are associated as traces of the transaction. This way, when a transaction is performed during several visits, the traces of two or several visits describe the different steps of the transaction.

In exemplary embodiments, during the step of storing in a permanent memory, said trace of the visited pages includes information about which portion of pages have been displayed. For example, the compression of the displayed image, performed at regular intervals and/or when a pointing device, such as a mouse, or a keyboard, are used, enables to implement such exemplary embodiments.

In exemplary embodiments, during the step of storing in a permanent memory, said trace of the visited pages represents only the portions of pages which have been displayed. For example, the compression of the displayed image, performed at regular intervals and/or when a pointing device, such as a mouse, or a keyboard, are used, enables to implement such exemplary embodiments.

Thanks to each of these features, said stored trace attests the information according to which the user has agreed upon a transaction.

According to particular features, said step of storing in a permanent memory includes a step of compressing images displayed on a screen available to a user, independent of said remote site.

In exemplary embodiments, said images compression includes a step of limiting the number of colours rendered and a step of compressing without loss of the image resulting from the step of limiting the number of colours rendered. For instance, the numbers of colours that may be affected to each pixel is in the first place reduced in such a way that the description of the colour of each pixel uses less than 8 bits. Thanks to each of these steps, the stored trace is reduced in size.

In exemplary embodiments, all the steps of said method are performed on the terminal 100, to the possible exception of steps in relation with a database that may as well be stored in terminal 100 as well as in a remote location away from terminal 100 but accessible by terminal 100.

Thanks to these features, the implementation of said method is easy because it is independent from the remote sites. Moreover, the user keeps that way the control of the implementation of said method.

In exemplary embodiments, the step of storing in a permanent memory includes a step of transmitting said trace to a remote memory. For example, said trace can be attached to an e-mail or kept in a memory space on a network available to the user (e.g. services known as “free drive” (registered trademark) or “xdrive” (registered trademark)). Thanks to these features, said trace can be stored by the user in a place of his choice.

In exemplary embodiments, the method as briefly described above includes a transmission to the remote site of a predetermined signal representing the implementation of said method. To that purpose, a communication protocol can be installed between the remote site 150 and the terminal 100. Thanks to this features, the user, on the one hand, and the remote site 150, on the other hand, can benefit from the implementation of the method object of the present invention and gain access to the same transaction trace.

In exemplary embodiments, the method as briefly described above includes a reception of information representing pages, e.g. addresses of pages having a legal content coming from said remote site, and during storage in a permanent memory, a trace of said pages contents is stored in memory, for example after using a browser to get said pages without displaying them. One notes that the information representing pages may include at least one address of a page of said remote site and/or one content of said page, for example.

In exemplary embodiments, the assistance software implements a step of transmitting, to the third party protection site 170, information representing the transaction detection. For instance, a database remote from terminal 100 may be queried only when a transaction takes place. For example, a database stored by terminal 100 can be updated only when a transaction is detected.

In exemplary embodiments, said step of storing a trace in a permanent memory includes a step of receiving information coming from the third party protection site 170 which is independent from said remote site.

Thanks to each of these features, said trace can be authenticated. One notices that information transmitted to third party protection site 170 or received from third party protection site 170 can include at least one of the following: a transaction number, a software license number, a date, an hour or one or more of the addresses of pages of the visited site that have a legal content, information representative of said remote site, an integrity certificate, e.g. a value calculated by a function known under the name “hash”, or a function known as “checksum”, or a function known as CRC (for correction redundancy code) each corresponding to at least a portion of the stored trace.

In exemplary embodiments, the method as briefly described above includes a step of selecting, by a user, of a transmission of information representing said trace or of said trace, remotely, and, in case of selection by the user, said step of transmitting. In exemplary embodiments, said step of transmitting includes a transmission of a file decompression software.

In exemplary embodiments, the method as briefly described above includes a step of determining an active window corresponding to a browser. Preferably, the stored trace in a permanent memory is not representative of activities performed when no active window corresponds to a browser. Thanks to these features, when a user keeps in background, as idle, a browser window, the trace is not representative of the other activities performed by said user, e.g. if the trace is generated by image compression.

In exemplary embodiments, the method as briefly described above includes a step of downloading or updating a database, at least partly. In exemplary embodiments, said database includes addresses used in said step of detecting a transaction. In exemplary embodiments, said database includes domain names. In exemplary embodiments, said update is performed whenever a transaction is detected. In exemplary embodiments, a partial updating of the database is performed whenever a visit start occurs. In exemplary embodiments, said update of the database is stopped after a predetermined period of time. Thanks to these features, at least one of the steps implemented by said method is performed in relation with said database.

In exemplary embodiments, said method includes a step of downloading a software designed to implement the other steps of said method and a step of installing said software during which a trace is remotely transmitted to determine that said software correctly runs. For example, during the installation, a predetermined page is automatically visited and transaction detection is simulated, then another page of another site is automatically visited and the resulting transaction trace is transmitted. Thanks to these features, the correct working of said software is automatically checked. For example, the missing of transaction start detection or the missing of the detection of the exit of the site on which the transaction has taken place can be detected.

In exemplary embodiments, the transaction detection and/or the visit start detection are performed only for certain predetermined remote sites, e.g. given by a database. Thanks to these features, said remote sites can offer their visitors an increased security level.

In exemplary embodiments, said trace is encrypted. Thanks to these features, the confidentiality of the information included in or represented by said trace is guaranted.

In exemplary embodiments, during the step of detecting transaction, a means of payment and a payment amount are associated with each transaction trace and stored in a permanent memory, e.g. by displaying an user interface device and/or by monitoring symbol or digit sequences corresponding to a means of payment. And, during a step of expenditure recap, an amount of expenditure performed with a means of payment or with all the used means of payment, is determined. In exemplary embodiments, during said recap step, a recap start date and a recap end date are used and the amount relates only to the transactions performed between these two dates.

In exemplary embodiments, the method as briefly described above includes a step of determining the available memory space for new traces. For example, a memory space is allocated by the user during the installation of the software and the availability of this memory space is monitored when it is progressively filled up with transactions traces and/or other traces. In exemplary embodiments, when said memory space is less than a predetermined memory space, a step of displaying information relating to the management of said memory takes place or a step of deleting at least the oldest transaction trace or a step of deleting at least the oldest trace corresponding to a transaction not including long term commitments, e.g. transaction about information provision.

According to a second aspect of the invention, the assistance software performs:

a step of detecting a start of a visit of a remote site,

a step of authenticating or electronically signing using user's asymmetric keys,

a step of editing during which at least a portion of a page of said remote site is selected by the signer and incorporated into a signed document and

a step of storing in a permanent memory a trace of signed pages of said remote site.

During the step of editing, the user selects the page of the remote site 150, for example by using a menu of the assistance software and at least one portion of the content of these pages (e.g. their textual content, the total of their content excepted the content originated by links, or the total of their content) is associated to the document to be signed, for example by edition and/or modification of the description, e.g. in HTML or XML languages, of the page including the document to be signed. Then, the modified document including each portion of the content selected by the user is signed and stored.

According to a variant pertaining to another aspect of the present invention, instead of or in complement of the page selection of the remote site, the signer edits and adds commentary to the signed document, e.g. by editing its description in HTML or XML languages. This way, the signer may add legal mentions like “provided the delivery takes place within 10 days”.

In each embodiment, the presence of the recording or trace allows the user to have at least one legal protection because a trace of the contractual agreement exists and also a financial protection because the payment is limited to the agreed amount.

The different aspects of the present invention and the different features of these aspects may be combined for the implementation of a device and a method for online transaction information backup in compliance with the present invention.

One notices that the information provided by the protection site 170 to terminal 100 may depend upon geographical locations where are located, on the one hand, the site 150 and, on the other hand, the terminal 100.

For instance, the information can represent payment sites (generally bank sites) of the country or the area of the remote site 150.

For instance, the laws applying to a transaction can depend upon these two geographical locations.

Depending upon the geographical location of the terminal 100, location that its user can indicate at the time of buying or at the time of installing the assistance software, the offer or the advertising of a local merchant near terminal 100 can be provided to terminal 100.

One notices that the confidential information or information “to be protected” may include all authentication or electronic signature using asymmetric keys, the assistance software then detecting the use of a routine or an authentication software or a signature stored in the terminal 100, or a form of information received from network 120 and representing the implementation of authentication or electronic signature using asymmetric keys or of a particular form of symbol sequence of a certificate of authentication or electronic signature using asymmetric keys, of a root of authentication or of electronic signature using asymmetric keys or an access to a function for authenticating or electronic signing using asymmetric keys. This way, the use of any form of authentication or electronic signature using asymmetric keys is a form of transaction detection.

According to a particular aspect of the present invention, the use of an authentication or an electronic signature using asymmetric keys generates a one-time payment means as for example a credit card number in the terminal 100 or in a computing device remote from this terminal but linked to it by a telecommunication network and this one-time payment means is used for the transaction. In a particular embodiment of the aspect of the present invention, the transaction trace stored in the permanent memory can be limited to the trace of the document to which are linked the authentication certificates or the electronic signature using asymmetric keys. In a particular embodiment of this aspect of the invention, the trace stored in the permanent memory is at least an address of at least one page received by terminal 100 from the merchant site (this page being possibly not displayed on the display screen 104 of terminal 100). In a particular embodiment of this aspect of the invention, the trace stored in the permanent memory is at least one of the files of at least one page received by terminal 100 from the merchant site (this page being possibly not displayed on the screen 104 of terminal 100). In a particular embodiment of this aspect of the invention, the trace stored in the permanent memory is at least one portion displayed on screen 104 of terminal 100 of at least one page received by terminal 100 from the merchant site. For the implementation of these different embodiments or these aspects of the present invention, the man of the art may refer to the rest of the present description or to the patent applications FR 9911250, FR 9912108, FR 9913401 and PCT IB/01312 incorporated here by reference.

Preferably, the trace or record stored identifies what has been displayed on screen 104 and possibly the duration of the display.

As a variant, the payment is secured by replacing the number of the payment card by a check number or a one-time payment card number that the remote site 150 can cash on the user account or on an account of the third party protection site 170 or of a third party insuring the payment. Preferably, according to this variant, the third party protection site 170 requests a confirmation, an authentication or electronic signature using asymmetric keys, of the user, transmits to the site 150 a confirmation of the payment order by said check giving the number of the check, the name of the merchant and the amount of the check. The payment is performed only if the delivery of the product or service sold has taken place. This variant has the advantage of keeping the money impounded until the delivery, to guarantee the merchant that he will be paid and to avoid the number of a payment card traveling on a network as Internet. One notes that in that case it is not necessary that the third party protection site 170 provides a root for the check number.

One notices that the term “one-time” covers the case when numbers are selected in a group of available numbers which are affected at random or according to predetermined rules to transactions in such a way that the risk that the same user can use the same one-time number twice in a row is inferior to one thousandth. The term “one time” covers also the case in which numbers are temporarily linked with a means of payment of the user, e.g. in a look-up table stored in a bank network.

In the embodiment shown in FIG. 2, following a step 200 of starting terminal 100 and automatically by the mere fact of the start of terminal 100, during step 201, the assistance software is automatically put into action and causes the display by the display screen 104, in a toolbar, of an icon specific to said assistance software. By clicking on this icon, by means of a pointing device such as the mouse 103, the user displays a menu including the following options:

record the visible portions of the page displayed,

record the page displayed,

start a recording,

edit the recordings already performed,

go to the transaction assistance site,

preferences/setup,

display information concerning a site,

suspend the assistance software process,

exit the assistance software.

The option “record the visible portions of the page displayed” initiates the storage of what appears on the display screen 104, together with a date and a time, and an integrity certificate of what is stored in memory. The integrity certificate allows the detection of any further modification of what is stored in memory, for example a hash value, a checksum or a CRC.

The option “record the page displayed” initiates the storage of the full page, a portion of which is displayed on the display screen 104, with a date and a time, and an integrity certificate.

The option “start a recording” initiate the storage of everything that is displayed on the screen 104 from the selection of this option until the selection of an option “stop the recording” (this last option appears automatically instead of the option “start a recording” when this later option is selected) together with a date and a time, and an integrity certificate.

The option “edit the recordings already performed” allows displaying a list of recordings stored, e.g. each line of a table corresponding to one of these recordings stored and from the left to right:

a symbol indicates if this recording concerns confidential information (for e.g., symbol “C”), if this recording concerns a financial transaction (for e.g., symbol “$”), if this recording concerns critical confidential information (for e.g., symbol “X”),

a integrity certificate number, at least for the financial transactions,

a date and a time of the recording, for example the start or the end of the recording,

the recording duration,

a date at which an action should be performed or observed (in particular a delivery related to a financial transaction) and at which the user will be asked about the correct completion of this action and/or about his satisfaction concerning the provider of this action, a message, for e.g., an e-mail representing at least one answer of the user, being then sent to the remote site or to a third party site, e.g. the third party protection site 170, in order to, as the case maybe, perform a processing of said answer of the user, for example, under the form of a claim sent to the site, to a legal protection insurance or to site 170,

the name of remote site 150 which pages or portion of pages are stored,

the presence or not of attached information, such as HTML pages of terms and conditions and

the size of the file including the recording in question.

Each of the recordings can be selected by using mouse 103. The table of recordings is displayed by means of controls which can be selected by using mouse 103 and which concern respectively:

activation of a display of the recording concerned by a previously selected line (by default, the first one), this displaying is performed with a little graphical interface representing the knobs of a videotape recorder VCR (read, stop and possibly backwards) and/or a scale with a cursor that can be moved to visualize the succession of images, the position of the cursor representing, in relation with the scale, the amount of time spent between the start of the succession of images and the image as compared to the total duration of the succession of images,

displaying the information attached to the recording,

add or modify comments relating to this recording,

delete a recording and

export a recording to another directory of memory 108 or to another memory.

The use of each of these functions is subject to an authentication of the user (requiring the provision of a password or any other kind of signature).

The option “go to the transaction assistance site” connects terminal 100 and the third party protection site 170 in such a way that the user of terminal 100 is enabled to visualize pages of site 170.

The option “Preferences/setup” allows to setup the assistance software and particularly the following features:

a password to control the assistance software (if no password has been chosen, all the controls are always open to any user),

“financial” information to be protected, including, for example, one or several of the following information items:

payment cards numbers,

bank accounts numbers,

passwords to reach payment software, payments site or directory/browser function of information which can be use to pay, directory/browser function known as “wallet”;

any other confidential information to be protected, considered as “critical”, such as social security numbers, ID documents, maiden name, children first name, children school name;

any other confidential information to be protected and considered as non critical, such as Zip code, street number, keywords like “boy” or “girl”;

the agreement to share (i.e., to send to a database, anonymously) a satisfaction indication and a timely delivery indication linked to an identifier of the concerned provider site;

the way that the assistance software reacts when it detects the input of critical information, i.e. asking for the password, displaying a warning window concerning the dangers linked to the transmission of this confidential information and/or storage in permanent memory of the recording in process when this critical information is detected;

the way that the assistance software reacts when it detects confidential but not critical information, by displaying a warning and/or performing a storage in permanent memory of the recording in process when this non critical information is detected;

the directory in which the recordings and/or the integrity certificates must be stored, i.e. in which directory, on which memory linked to a local area network, on the third party protection site 170, on a trusted third party site 180 (one notices that several destinations can be chosen simultaneously for these recordings);

if the recordings concerning no confidential information must be stored;

when the confidential information monitoring must take place, for example, either all the time or as soon as a browsing software is activated, or only when the user is connected to a remote site;

an amount of memory allocated to the recordings of the assistance software.

It should be noted that the information to be protected may include keywords associated, by construction, to the assistance software such as “signature”, “order form”, “credit card”, “address”, “e-mail”, “Visa” (registered trade mark), “MasterCard” (registered trade mark) or keywords referenced in a database accessible by the user terminal, for example in front of each site listed in this database, in front of the country corresponding to the site in this database (the site country being identified by the ending of the domain name or a request to a domain name server DNS) or for all the visited sites.

The choice of each of these parameters is subject to an authentication of the user (password request or any other kind of signature).

The option “display information concerning a site” allows to display the information concerning the remote site 150 that the user visits, information accessible to terminal 100, for example by being stored or retrieved by the third party protection site 170.

The option “suspend the assistance software process” allows to suspend the transaction surveillance.

The option “exit the assistance software” allows to stop the assistance software process and to delete or not the recording in process, according to variants.

The choice of each of these two last functions is subject to an authentication of the user. When the menu is selected, the password is however requested only once until the menu is closed.

To simplify the description concerning technical functions well known by the man of the art, the implementation of the above functions is not described in details here.

Then, during the assistance software processing, when the options of the menu of the assistance software are not displayed or used, during a test 202, it is determined if the transaction surveillance must start. This test 202 depends upon the setup or the menu options chosen by the user as described above or upon the default software setup. As a variant, the result of the test depends upon the sites already visited by the user since he activated terminal 100. For example, the surveillance starts only after visiting a predetermined site or a predetermined address, e.g. an internet provider site, a legal protection site or a search engine.

When the result of test 202 is negative, test 202 is rerun. When the result of test 202 is positive, during a test 203, it is determined if a transaction surveillance must stop according to setups and options of the menu selected by the user. When the result of test 203 is positive, test 202 is rerun. When the result of test 203 is negative, during a test 204, it is determined if terminal 100 is connected to a remote site. For example, during a step 204, it is determined if terminal 100 is connected to a remote site 150 by issuing a connection request to another remote site, for example a domain name server (DNS) and by monitoring the answer. According to another example, it is determined if terminal 100 is connected to a remote site by determining if the active window on this terminal 100 is a browser window (for e.g., Microsoft Internet Explorer, registered trademarks, or Netscape Navigator, registered trademarks).

If the result of test 204 is negative, test 205 is performed. If the result of test 204 is positive, step 207 is performed.

During test 205, it is determined if information to be protected is used. The detection of information to be protected can be performed in different ways, as for example:

by monitoring the symbols entered on keyboard 105 and comparing these symbols with the information to be protected given by the user when installing or setting up the assistance software,

by monitoring other means (not represented) of information inputs (such as a microphone and a voice recognition device) and comparing these inputs with the information to be protected given by the user when installing or setting up the assistance software,

by monitoring the received information (for example, by optical character recognition and/or keywords detection in an e-mail received or being written, keywords such as “signature”, “order form”, “credit card”, “address”, “e-mail”, “e-mail address”, “Visa” (registered trade mark), “MasterCard” (registered trade mark), . . . )

by monitoring the content of the clipboard to find out information to be protected given by the user when installing or setting up the assistance software,

by monitoring the copying of files stored in memory 108, files which may contain information to be protected (these files are detected, in a known manner, by searching in all the files kept in terminal 100, as soon as new confidential information is given by the user as information to be protected during a setup step) and/or

by monitoring the use of routines or of software used for an authentication involving asymmetric keys or for a signature using asymmetric keys (see in particular the crypto-API and the ActivX).

For example, the monitoring of the information to be protected consists in comparing the features of information to be protected with features of information used in terminal 100, all the time or during surveillance periods and when these features match, considering that information to be protected has been detected and consequently that a transaction is detected.

If the result of test 205 is negative, test 204 is rerun. If the result of test 205 is positive, during step 206, the processing of the detection of the information to be protected is activated. According to the user's setup or to the default software setup:

a warning window is displayed, the content of which depends preferably on the detected confidential information,

the image displayed when confidential information is detected, is stored,

a user authentication is requested, for example by requesting a password.

After step 206, test 203 is rerun.

During step 207 and when a user visits the remote site 150, the assistance software performs different steps:

whenever the user reaches a new remote site which is not a site on which a transaction, started on a previous remote site, can be continued (as described elsewhere in the present description), the assistance software starts a recording which is stored in memory 108 and the icon specific to the assistance software begins to blink in the toolbar,

whenever the user reaches a new remote site which is not a site on which a transaction started on a previous remote site can be continued (as described elsewhere in the present description) the assistance software provides the third party protection site 170 with an identifier of the new remote site 150, and waits for return information concerning the new remote site 150 (satisfaction rate of the previous customers, punctuality rate observed by the previous customers, privacy respect rate, legal content pages addresses, e.g. terms and conditions, warranty, refund policy, delivery, confidential information processing, site country, main customer protection laws applying to the transaction). When terminal 100 waits for the answer, the icon blinks in orange. If information is received from site 170 within a predetermined time period, the icon starts blinking in green, and if not, the icon starts blinking in red,

whenever the user exits a remote site 150 without visiting another remote site which is not a site on which a transaction started on the previous remote site may be continued (as described elsewhere in the present description) when no transaction has been detected, according to the user setup or the default assistance software setup, either the recording is deleted or it is stored and put on a list of recording with an indicator that allows it to be automatically deleted after a predetermined storage duration or according to the memory space available for the recordings of the assistance software. In that case, according to variants of the embodiment of the present invention, this recording is equipped or not with an integrity certificate.

One notices here that the recording preferably includes an image compression without loss of what is displayed on screen 104, for example, each second, when during said second, the pointing device (the mouse) has been used either by moving it or by depressing one of its buttons or if the keyboard or another data input device has been used.

The recording includes, for each image, the time (including minutes and seconds and optionnaly, second fraction) when it was taken or, which is equivalent, which time period has separated the shooting of this image from the next image shooting. This way, the succession of images displayed on screen 104 may be visualized later with the display duration of each image corresponding to their initial display duration. This way, the recording allows restoring, for example in video format, such as AVI format well known by the man of the art, a visual animation of the site visit.

For instance, this enables any device compatible with this type of format to visualize the recording in question.

During test 208, it is determined if a transaction is detected. The transaction detection can be performed in different ways, as for example:

by monitoring the symbols typed on keyboard 105 and comparing them with the information to be protected given by the user when installing or setting up the assistance software,

by detecting the switching to a secured communication mode (encrypted), for example, by detecting the presents of the root “https” in a received page address,

by monitoring other (not represented) means of information inputs (such as a microphone and a voice recognition device) and comparing them with the information to be protected given by the user when installing or setting up the assistance software,

by monitoring the information received (for example by optical character recognition and/or keywords detection in the description of the page in language HTML or XML, keywords such as “signature”, “order form”, “credit card”, “address”, “e-mail”, “e-mail address”, “Visa” (registered trade mark), “MasterCard” (registered trade mark),

by monitoring the content of the clipboard to find information to be protected given by the user when installing or setting up the assistance software,

by monitoring the copy of files stored in memory 108, files which may contain information to be protected (these files are detected, in a known manner, by searching in all the files kept in terminal 100, as soon as new confidential information is given by the user as information to be protected),

by monitoring the routines or the software used during an authentication by asymmetric keys or a signature using asymmetric keys (see in particular the crypto-API and the ActivX),

by comparing the address of the visited page with addresses stored in a database accessible to terminal 100, related to the visited site (for example, the address of the received page is compared only with one or several addresses corresponding to the visited site identified by its domain name in a database accessible to terminal 100) and/or

by comparing the address of the visited page with addresses stored in a database accessible to terminal 100, when the visited site is not listed in it (for example bank sites payment pages addresses or social or fiscal declarations sites addresses).

One notices that for keywords detection in the page description, one can either scan the information passing through a communication port of terminal 100, or related to a browsing software, or use a reading routine of the page description and search for the keywords in this description.

One notices that, to implement particular above methods, the assistance software performs a request to the third party protection site 170 by providing the domain name of the remote site 150 and, in return, receives:

if the remote site is listed in a database of site 170, pages addresses indicating a transaction or preparing a transaction (shopping cart, order, payment, cart, checkout, “one-click” order) and/or domain names of at least one site associated with remote site 150, associated site on which a transaction started on remote site 150 can proceed (for example payment site or site associated to the domain name with an ending or extension different from that of the domain name of the remote site 150) and/or keywords to be monitored on remote site 150, and/or an indication of type of transaction possibly performed on site 150 (first hand purchase, second hand purchase, auction, refurbished goods, transportation tickets, product or services for underage persons, information providing, products or services, partner site of protection site 170, administrative declarations, use of an electronic signature using asymmetric keys),

if the remote site is not listed in a database of site 170, addresses or names of sites of the same country or geographical region as remote site 150 and dedicated to the finalization of transactions (for example to sign or to pay, outside of the remote site) and/or keywords liable to indicate a transaction.

If the result of test 208 is negative, test 204 is rerun and step 207 is continued as long as the result of test 204 is positive. If the result of test 208 is positive, during step 209, transaction processing is performed. According to the user setup or default software setup:

an information window, the content of which is contextual and depends upon the remote site 150, is displayed (for that purpose, a request to site 170 that can be identical to the request described above, is sent to site 170 to receive, in return, the addresse of the pages of site 150 including legal content, administrative forms or general sales condition; information depending on site 150 country, for example an overview of the consumer protection laws or declaring party protection laws applying to the transaction; information related to site 150, for example access to best price search engine or offers from competitor of site 150 or advice concerning the site 150 usual type of transaction (auctions, second hand goods or refurbished goods purchases, children goods purchases . . . ); and information independent from site 150 (advice to online buyers, for instance),

the recording in process is stored in the chosen location (the storage in permanent memory can be performed in one or several of the following locations: in terminal 100, in protection site 170, by sending a file to an internet address or a predetermined e-mail address or in a trusted third party site 180, by registration in a secured database), as soon as the user exits said remote site 150, the recording is associated to an integrity certificate, a certified registering date (being issued by protection site 170), the contents of the legal pages of said 150 site, as the case maybe (terminal 100 sends a request to third party protection site 170 to get the URL addresses of the remote site 150 legal pages, then downloads these pages from remote site 150, without displaying them on screen 104 and stores them in their original format, for example HTML or XML),

a duplicate of the integrity certificate is sent to protection site 170, with as the case maybe, the list of pages of remote site 150 (and all the sites on which a transaction started on remote site 150 has been continued, as described elsewhere in the present description) visited by the user, for example to generate a recording representing the recording stored by the user but including only the addresses or including the content of pages in HTML format (and not compressed succession of images as in the user's recording), in order to testify, in case the relation between the user of terminal 100 and site 150 should give way to a further dispute,

as soon as the user exits said remote site 150 or a site on which a transaction started on remote site 150 can be proceeded as described elsewhere in the present description, a window asking the user at least one realization date or a further action recall, such as the delivery of service or product ordered, is displayed and the user can choose a date at which this action will be recalled: by default, the date is set after a predetermined time period according to the transaction date, said predetermined time period depending on the transaction type, of the laws applying to the transaction with the site (see others embodiments of the invention), for example if the user has a seven day time period to cancel an order, at the end of this time period, a window is opened on the screen 104 of terminal 100 and ask the user if he wants to cancel his order, if he answers “yes”, the assistance software gives access to a page of the third party protection site 170 which enables to send an e-mail to the address of the consumer service of remote site 150; for example, if an average delivery time for this type of transaction on remote site 150 is indicated as “10 days”, in the database of protection site 170, and if the user doesn't change this time period in his answer, after this time period of 10 days following the transaction, a window is automatically opened on screen 104 to ask the user if the delivery has taken place and is satisfactory and if the answered is “no”, the user is asked to choose a new date (and the procedure starts again) or to send a complaint to the remote site 150 or to the third party protection site 170, by accessing to a page of third party protection site 170 allowing to answer different questions (tree structures) for the user to indicate which type of problem he met, for him to automatically send, with his answers to the questions, a copy of the trace concerning the transaction in question, and the next steps he wishes in relation with his complaint. Then the complaint is automatically processed by third party protection site 170 or remote site 150 to satisfy the user,

user identification is requested, for example as a password request.

One notices that, according to an indication of a transaction type possibly performed on remote site 150 (first hand purchase, second hand purchase, auction, refurbished goods, transportation tickets, products or services for underage persons, information providing, products or services, partner site of protection site 170, administrative declarations, use of an electronic signature using asymmetric keys), the transaction processing may vary, for example: storing during different time periods or in different locations of the recording, displaying of different orders or advice. For example, for the type “transportation tickets”, the recording can be stored on a third party protection site 170 to allow the user to immediately claim his rights if, when he shows up for boarding, he is told that transportation ticket hasn't been issued. For example, for the type “products or services for underage persons”, the transaction processing includes, for sites in a list of “prohibited” sites reserved for adults, a special warning for underage persons, sending an e-mail including or not a copy of the recording, or calling the phone number of the parents). For example, for the partner sites of protection site 170, no advertising is displayed but a signal representing the presence of the assistance software on terminal 100 is sent to terminal 150 with or without the recording transmission. For example, for administrative declarations, the assistance software proposes to the user to store the recording on a compact disk, the life duration of which can exceed the life duration of terminal 100 or to store the recording on one of the sites 170 and 180. For example, for second hand purchases and/or transport tickets, storage duration of the recording can be six month, the user of terminal 100 being proposed, at the end of six month after the transaction date, to delete the recording but, for the first hand purchases, the duration is increased to two years. For example, for particular types of transactions, such as information provision, the compression of the data of the recording is different, for example more compressed than for other types of transactions. This compression can indeed be progressive in time according to the type of transaction, for example with a compressed images file during a first duration depending or not upon the type of transaction then without images file or with an image file more compressed later. For example, when no electronic signature is used, the recording is automatically sent to trusted third party site 180.

After step 209, test 203 is rerun.

One notices, that according to variants, the stored images include or not the position of the cursor of the mouse 103 or a compatible pointing device. To that purpose, the assistance software permanently acquires, on the one hand, the image displayed on the sceen according to known processes, and, on the other hand, the shape of the mouse cursor and its coordinates on the screen. The assistance software then inserts the cursor in the acquired image in the location indicated by said coordinates and records the resulting image.

As soon as the recording of the final transaction image has been stored in permanent memory for longer preservation (i.e. longer than the time period until turning off the terminal 100), the assistance software computes a mathematical combination of the recorded data (for instance a function known as “hash”, a function known as “checksum” or a function known as “CRC” for correction redundancy code). This mathematical combination is called integrity certificate for if the file is later modified, the value of this mathematical combination will change in such a way that that further modification will be detected. Terminal 100 or assistance software then sends to third party protection site 170 the following data:

serial number of assistance software,

domain name or URL internet address of site 150,

the integrity certificate,

the size of the compressed images file,

the universal time and hour on terminal 100 at the end of the transaction.

In return, the assistance software gets and stores, associated to that recording, from site 170:

an unique number identifying the transaction on server site 170,

the date on server site 170 when the transaction was recorded,

the date on terminal 100 of the transaction recording (so as to confirm that the received date is corrected to get exactly what is recorded in a server to take into account time zones problems).

When exporting (function selected by means of the assistance software menu and of the recording edition option), the assistance software generates three types of files, compressed or not:

files of pages of site 150 having a legal contents (for example in format HTML or XML),

images files, for example in a video format, such as AVI,

integrity certificate including another integrity certificate computed from the files of pages and the images files, and the size of these files.

It also includes the original transaction number and the recording dates of the server of site 170 and of terminal 100, the integrity certificate of the original images files, its size and each date of action recall to the user that should be perform. An integrity certificate is also computed on the main integrity certificate. It associates to these files a compression and integrity certificate computing software. This way, the addressee of these exported files will be able to detect any change made after they were created, on one of the exported files, by recalculating the integrity certificate and comparing it to the received integrity certificate. He will be able to verify the validity of the received integrity certificate by request send to third party protection site 170.

For example, the integrity certificates are computed according to the method known as CRC 32 or CRC 128 bits.

According to a variant (not represented), in a local area network, each of the terminals has assistance software and performs the steps listed in one of the embodiments described above and stores locally the recording or trace it generates. Then, at regular time periods, for instance every night, the recordings are collected by a network server from all the networks terminals.

In exemplary embodiments, a step of dating allocates a date to at least one of the steps of receiving and storing in permanent memory, said date being stored associated to the information representing said succession of pages and the integrity certificate allows detecting a modification to said date after its storage in permanent memory. Preferably, such a dating is performed by reference to a clock independent from terminal 100.

In exemplary embodiments, the display duration of each remote site 150 page is stored together with the information representing said page. As a variant, the integrity certificate enables to detect a modification to said duration after its storage in permanent memory. This way, the recording can give evidence of the duration of the communication in question.

In exemplary embodiments, during the storage in permanent memory, are stored indicators of which portions of the received page have been displayed during the step of displaying. This way, the recording can give evidence of what the visitor has seen during the site visit (also called “communication with the site” in the rest of the present description) but also of the content of the pages that the user has not seen, while using a format of total page description, this format (e.g. HTML) permitting to store the data better compressed than for instance in an image format.

In exemplary embodiments, during the step of storing in permanent memory, are not stored portion of pages received from site 150 upon request (click or URL address entry) of the user, which are not displayed during the step of displaying. This way, the quantity of stored information is limited to the information that gives evidence of what has been seen by the user. However, this information can be completed by pages received from site 150 without user's request (downloaded legal pages as indicated above).

In exemplary embodiments, the recording stored during storage in permanent memory includes information under text format of the pages received from site 150.

In exemplary embodiments, a step of deleting a recording is performed, said step of deleting depending upon the detection of transaction with remote site 150. This way, the recording can be stored for a time duration depending upon the fact that a transaction has taken place or not during the communication concerned by the recording.

According to a variant, only sites represented by a domain name in a database accessible to terminal 100 (existing on this terminal or on the site 170 for instance) are monitored (the detection of these sites is performed by comparing the address of the active browser with the domain name stored in the database).

According to a variant, the recording is suspended as soon as a transaction has been detected in order to prevent the user's confidential information from being stored in memory in the recording. Then, the recording includes the conditions in which the user has agreed to contract and as the case maybe, the pages having a legal content of remote site 150.

According to a variant, a copy of the recording related to a transaction is sent to the site after verifying that the site accepts this recording, according to a request/answer communication protocol.

The embodiment shown in FIG. 3 more particularly concerns the case when the user performs transactions with a portable terminal (different from terminal 100) which has not enough available memory space to store the information or traces of each transaction. For example, this portable terminal is a cellular phone, a PDA or a portable, ultra portable or pocket computer. The assistance software is then activated in a computer system which receives information representing the information received by the user terminal. For instance, the assistance software works at least partially in a server of a portal site or internet service provider (ISP) through which the user gains access to the communication network resources. Another portion of the assistance software is implemented in a terminal such as terminal 100 to receive recordings performed by said server for example under the form of e-mail attached files. This other portion of the assistance software can be similar to the assistance software illustrated in FIGS. 1 and 2, with furthermore a recording importation function performed from a portable terminal.

To simplify, in the following description, we consider only the case when only the transactions are protected, i.e. the transaction is detected in relation with the financial information to be protected, an authentication or electronic signature using asymmetric keys, or addresses, domain names or visited pages contents. However, with or without adding a portion of the assistance software installed in a portable terminal, the other transactions detection mode indicated in step 208 (FIG. 2) can be implemented.

After a step 300 of starting the portable terminal and connecting this portable terminal with the server implementing the assistance software, during step 301, the assistance software is automatically activated and causes the display of a icon specific to said assistance software, on video screen 104. By selecting this icon, the user gains access to the online functions of the assistance software and, in particular, a menu that includes the following options is displayed:

start a recording,

preferences/setup,

display the information concerning one site and

suspend the assistance software process.

These options have already been detailed in FIG. 2. However, one can observe that their implementation is made on line by the assistance software, each option selection giving way to a request to this assistance software in the same manner as a hypertext link between the internet pages.

Then, during the assistance software process, when the assistance software menu options are not displayed or used, during a test 302, it is determined if the transaction surveillance must begin. This test 302 depends upon the setup or the menu options chosen by the user as described above or upon the default software setup. When the result of test 302 is negative, test 302 is rerun. When the result of test 302 is positive, during a test 303, it is determined if the transaction surveillance must be ended. This test 303 depends upon the setup or the menu options chosen by the user or upon the default software setup. When the result of test 303 is positive, test 302 is rerun. When the result of test 303 is negative, during a step 305, and while the user uses his portable terminal to communicate on the network, the assistance software performs different steps:

each time the user gains access to a new site, the assistance software starts a recording of everything is sent to the user, this recording is stored in the server,

each time the user gains access to a new site, the assistance software tells the user if he has information concerning the visited site (satisfaction rate of the previous customers, punctuality rate observed by the previous customers, privacy respect rate, legal content pages addresses, e.g. terms and conditions, warranty, refund policy, delivery, confidential information processing, country of site, main customer protection laws applying to the transaction . . . ),

each time the user exits a site without any transaction being detected, depending on preferences chosen by the user or on default software setup, the recording is either deleted or stored in a location chosen by the user. In that case, according to exemplary embodiments of the present invention, this recording is associated or not with an integrity certificate.

The recording includes, for all the information sent to the user's terminal during the browsing, the communication time (including date and hour, minute, second and possibly fractions of second) and its precise duration.

Then, during test 306, it is determined if a transaction has taken place in one of the described manners presented with step 208 on FIG. 2.

If the result of test 306 is negative, step 305 is continued. If the result of test 306 is positive, during step 307, the processing of transaction is performed as indicated with regards to step 209 (FIG. 2).

After step 307, test 303 is rerun.

One notices here that for each embodiment of the present invention, the transaction monitoring can for instance be permanent only when a network communication software runs (such as access software of an internet service provider and/or e-mail software), only when the terminal is connected to another computer system through a communication network, for example internet or intranet or only when the terminal is connected to another computer system through a communication network secured connection. This can be setup by construction, by default or by assistance software setup chosen by one of the users for instance.

In exemplary embodiments, the implementation of the step of storing recording in memory depends upon the detection of a transaction during the communication with one remote site 150. For example:

if a financial transaction or a signature is detected, the storage of the recording is performed and includes, in a compressed image format, the succession of images displayed on screen 104 (the portions of pages received from the site and displayed). The content of HTML legal pages of site 150, the certified date and an integrity certificate of the recording and a storage in a text format in the protection site 170 of the text files of the pages received by terminal 100 and of legal content pages of this site,

otherwise, if critical confidential information is detected, HTML pages received from the site are stored together with a legal content page specifying the site policy concerning privacy and/or protection of confidential data,

otherwise, if confidential non critical information is detected, only the files of the text of the corresponding pages are stored,

otherwise, no information storage is performed.

In the same way, the recording automatic deletion, the time of this possible automatic deletion, the recording compression, and/or a request from the user for this recording to be deleted, preferably depend upon the type of information to be protected (financial critical or not) concerned by this recording.

The reader will be able to refer to the description of the other embodiments and to the documents incorporated by reference for the implementation of each technical feature of the embodiment presented here.

In the case of an access to internet through a device having little available memory space, the recording or simplified recording (e.g. the recording of one portion of the information received by the terminal) maybe sent automatically to a given internet address, to a document preserving site such as Xdrive (registered trade mark) or attached to an e-mail address chosen by the user.

In the case of an access by means of a cell phone, the access portal can perform the functions presented above regarding one of the other aspects of the present invention.

According to a variant (not represented), the assistance software protects the user by automatically transmitting to site 150 or to a remote addressee, information completing the communication with this site or this addressee. This transmission or this complement depends upon at least one of the following criteria:

the identifier of one person party in the communication and/or

the content of the information dealt with the communication parties.

In exemplary embodiments of a seventh aspect of the invention, said added information includes a limitation of the legal value of said communication. For example, the added information announces: “a communication has taken place with a member of the firm personnel, any commitment of the firm is bound to the signature of a legal representative. The addressee is bound to check if it is necessary to confirm the content of the communication which took place with an executive of the firm. To get a signature, click here”. The fact of selecting the word “here” triggers the transmissions of secured information representative of the initial communication with a member of the protected firm hierarchy, for him to validate (for e.g., by electronic signature) or invalidate the content of said initial communication.

Thus, in a firm using the assistance software, depending upon the identity of a user in the firm, of the identity of an addressee and/or of the detection of information to be protected (e.g. the keyword “prejudice”, “contract”, “engage”, “repair”, “euros”, “dollars”, “free” . . . ) the assistance software triggers either an addition to an e-mail or the sending of a complementary e-mail to the addressee or to a third party to reduce the legal value of the communication between the user and the addressee.

Preferably, the user in the firm is informed of the recording storage and the communication recording is certified (dated and given an integrity certificate) and stored by the firm as explained above.

In a variant, the assistance software requests an authentication of the user and if he is not authorized to make a commitment in the name of the firm, warns him of the danger in the communication process and/or that the trace of this communication is being sent to a firm representative or a legal counsel of the firm (these steps, well known by the man of the art, are not recalled here).

FIG. 4 represents the implementation of the present invention in connection with an electronic signature. This implementation includes independent aspects of the invention:

the electronic signature depends upon the contents of a large number of pages,

said pages are edited by the user, except the page where the signature is requested,

the electronic signature triggers the storage in permanent memory and the storage of information representing the plurality of pages,

the detection of an electronic signature affects the recording (format and/or content), its storage duration, its storage location, and/or the associated information (integrity certificate, date, supplemental information).

On FIG. 4, after a terminal has been activated and the assistance software has been initialized, step 400, during a test 401, it is determined if asymmetric keys electronic signature (this term covering also the asymmetric keys authentication) is requested. For instance, a software routine representing the implementation of a signature is detected (crypotAPI or ActivX detection, for instance) or information received from the site indicating that an asymmetric keys electronic signature is detected. When the result of test 401 is negative, test 401 is rerun. When the result of test 401 is positive, a graphical user interface asks the user to indicate which other pages of the site, except the page in which asymmetric keys electronic signature are requested, are related to the transaction. The user can then return to the pages he has viewed to associate them to the document to be signed.

The user can also accept or decide that all the recording or what he has viewed on the visited site are enclosures of the signed document. Finally, the user can accept or decide that the pages having a legal content registered by the protection site 170, be enclosed into the signed document.

According to the type of asymmetric keys electronic signature, the content to be signed is then given an integrity certificate which certifies the signature or the content to be signed or given a root for the signature to be generated.

The total content chosen by the user or, as a variant, the recording concerning the visit of the site requesting the signature without the user being allowed to modify this content, is stored at a location chosen by the user and a message concerning this storage is sent to the site, step 402.

This way, the detection of an electronic signature can trigger the storage in permanent memory or the modification of the recording (format and/or content), its storage duration, its storage location, and the associated information (integrity certificate, date, supplemental information), for instance.

In exemplary embodiments, during the step of storing in permanent memory, the recording represents a plurality of pages. Therefore, it is not only a sales order, an administrative declaration or a one-page document which is stored but a plurality of pages, for instance a plurality of said succession of images or a plurality of pages including legal content pages issued by said remote site.

Preferably, during the step of storing in permanent memory, the recording represents at least one page in which said electronic signature is requested. According to a variant, during the step of storing in permanent memory, the recording is representative of each page visited by the user.

In exemplary embodiments, a step of determining the start of the contract document and a step of determining the end of the contract document are performed and during the step of storing in permanent memory, the recording represent each page accessed between the beginning and the end of the document. This way, the signature may depend upon a group of information that the user considers as contractual and which he wants to be signed by the signature, knowing that, only when he reaches the document to be signed, he needs to visit or revisit the pages he considers as baring information that motivated his agreement and, to sign them, to come back to the document to be signed to associate these pages to this document. As a variant, the use of the assistance software menu allows the user to select the pages to be associated to the document to be signed, an option “sign the display page” being therefore included in this menu.

In exemplary embodiments, a step of associating an integrity certificate to the recording is performed, said integrity certificate being stored in association with the recording.

An eigth aspect of the present invention concerns a transaction information backup method that includes:

a step of communicating, through a communication network, during which information is received by a terminal from said network,

a step of storing in permanent memory of data representing information coming from said communication network during this said step of communicating,

during said step of storing in permanent memory, a step of detecting a transaction, depending on the information received from said network by said terminal during said step of communicating and

a step of keeping said stored data step, depending upon the results of said step of detecting.

FIG. 5 represents information communications between different terminals or servers, that implement an exemplary embodiment of the present invention.

The names of the functions implemented by these terminals or servers are given in the first upper line of FIG. 5. From left to right:

servers of site 700 to 710,

user terminal 712,

third party protection server 714,

trusted third party server 716.

The assistance software is permanently installed on terminal 712 (it is started automatically during the activation of the user terminal) and read the addresses (URL) of the visited sites, for example, by reading them on each active browser. When a browser is active, the assistance software monitores the transaction as indicated facing FIGS. 1 to 4. For example, by monitoring the information to be protected, e.g., credit card number and keywords; and/or routines and software involved (for example, transaction data storage software known under the name of “wallet”, driver of memory card reader or crypto API used during a step of authenticating or electronically signing) and/or the contents, the domain names or the pages addresses received from site of terminal 712. The storage performed below includes information compression, especially when it concerns a succession of images displayed on a terminal screen, and encryption. For the image compression, it is better to reduce the numbered of colours used and the numbers of stored screen shots (for instance one or two per second).

During a communication step 720, the user terminal 712 opens a communication session with the server of site 700. During a step 722, the assistance software starts a storage in a file of a so-called “transaction file”, of information related to the communication session, for example the storage of pages received by terminal 712 from site 700, or of a file of compressed images of what is displayed on the user terminal screen 712 as long as the browser giving access to site 700 is active, and queries the third party protection server 714 by a request identifying the site 700. To that purpose, the assistance software monitors the active window and suspends the storage of the transaction file when the active window is not a browser window. During step 724, the third party protection server 714, which is supposed to store the data about site 700 in a database updated by a content search robot and/or by manual inspection, returns a data file related to site 700. This file includes at least information allowing the detection of a transaction preparation on site 700. In exemplary embodiments, the file transmitted by server 714, on request of terminal 712 (identifying the visited site for example by its domain name), includes at least one of the following information items:

an address of at least one shopping cart page of site 700 which is displayed when one selects a product or service (when using a “cart” or a “shopping cart”),

an address of at least one order page of site 700 met when one files an order form or makes a purchase (“checkout” or “one-click”),

an address of at least one site page where one can perform a payment by giving an identification of a payment means (for example a credit cart number),

an address or a domain name of at least one payment site page, for instance, a bank site, on which one is directed by site 700 when one wishes to pay,

an address or a domain name of at least one page that one reaches when one wants to provide a signature or a buyer's authentication and

one keyword indicating of transaction on site 700 or a type of transaction on site 700 allowing terminal 712 to identify such keywords.

In the exemplary embodiment shown in FIG. 5, the file sent by server 714 includes an address or a domain name of at least one server or site on which the transaction can be continued (for example in case of credit request, when the site 700 uses several servers or domain names or when site 700 is associated with shopping mall in which the customer can perform multisite transactions) if such a site exists.

The information received from the third party protection site 714 is stored in memory by terminal 712 in a dated file called “commercial”.

During a step 725, user terminal 712 ends the communication session with site 700 and no transaction or product or service selection has been detected and opens a communication session with a site 702 which is not identified in the commercial file as a site on which a transaction started on site 700 can be continued. Terminal 712 deletes the transaction files concerning site 700 but saves the commercial files concerning site 700. As a variant, the assistance software stores the transaction files for a time duration depending upon the memory space available for transaction files, until the amount of available memory becomes less than a threshold value and that the transaction file in question is or becomes the oldest transaction files not related to a transaction, stored by terminal 712.

During step 726, the assistance software begins a storage in a file called “transaction file”, of information related to the communication session with site 702 as indicated above for step 722, and queries the third party protection server 714 by sending a request identifying site 702. During a step 728, the third party protection server 714, which it is assumed here that it stores data about site 702, returns a file as indicated during step 724 and all or part of this information is stored in a dated commercial file.

One assumes here that site 702 uses several servers, several domain names or that a transaction can be continued on several sites which are identified in the commercial file corresponding to sites 702. For example, the transaction is continued on a server or site 704. In that case, during a step 730, the terminal 712, recognizes the address or domain name concerned, doesn't stop the generation of a transaction file related to site 702 but, to the contrary, complements it during the visit of site 704.

It is assumed here that the user of terminal 712 decides to perform or to prepare a transaction on site 704, for example by selecting a product and putting it in the shopping cart or by sending an order.

During a step 732, the terminal 712 then detects the transaction, either when one of the addresses, one of the domain names or one keyword in the description of the page (for example, in format HTML or XML) is identified as indicating a transaction when compared with the content of the commercial files corresponding to site 702, or by comparison with predetermined keywords indicating transactions stored in terminal 712, or when the assistance software detects information to be protected (for example keyboard inputs of terminal 712) which is predetermined transaction indicating data (for example credit card number given when the user installs the assistance software and stored in an encrypted way), or even when the use of a routine or of a software indicates a transaction (for example, transaction data storage software known under the name of “wallet”, driver of memory card reader or crypto API used during a step of authentication or asymmetric keys electronic signature).

One notices that, for the detection of keywords in page description, one can either scan the information passing through a communication port of the terminal, or related to the browser software, or use a routine reading the page description and search the keywords in this description.

During step 734, terminal 712 sends a new request to the third party protection server 714, giving it an identifier of site 702 or site 704, to receive in return information which can be useful for the assistance software or for the user of terminal 712. For instance, the file transmitted by server 714 includes:

at least one adresse of a page of site 700 having a legal content (general sales conditions),

one certified date and hour,

other information concerning site 702 and/or site 704 (satisfaction rate of previous users, delays in answering phone calls or e-mails, country or state location, consumer service e-mail address, competitor's sites, transaction types . . . ), information about consumer protection laws applying to transactions on site 702 or 704 and information independent from sites 702 and 704 (advice for online buyers, access to at least one best price search engine, advertisement, access to consumer protection site).

During step 736, the assistance software downloads each page of sites 702 and/or 704 having a legal content and incorporates it in the transaction file, for example under the original description format, e.g. HTML or XML. As a variant, during step 738, server 714 downloads each page of sites 702 and/or 704 having a legal content and associates it to the request received from user terminal 712 with, for example, the date, hour and a user identifier.

As an option, during step 740, the assistance software displays on the screen of terminal 712 all or part of information that can be useful for the user, including under the form of links giving access to the pages stored by server 714 or buttons allowing access to details (access to applicable laws, to the site practice, to advice, to service offers).

During step 742, the user goes on with the transaction, for example, by paying online on site 704 or on a payment site 706 identified in the commercial file. The building of the transaction file continues during the payment. During a step 744, the user ends the transaction by gaining access to site 708 which is not identified in the commercial file as related to one of the sites 702 or 704.

During step 746, the assistance software associates to the transaction files including each page of sites 702 or 704 having a legal content, a certified date and hour (received from server 714 or due to a new request on this server).

During step 748, the assistance software determines an integrity certificate (hash value or checksum, CRC or redundancy code) of the transaction file, this certificate allowing the detection of any further modification of the transaction file, and stores this integrity certificate with the transaction file and the certified date and hour, the whole being called “digital contract”.

During step 750, the assistance software sends the integrity certificate to third party protection server 714 which stores it with the certified date (for example obtained by request from three sites providing such a date) and possibly an identifier of the concerned site (702 and/or 704).

It is assumed here that site 708 is a site on which one can file an administrative form, for example social security or tax papers. During step 752, the assistance software starts a storage in a file called “transaction file”, as indicated above, and queries the third party protection site 714 by a request identifying site 708. During step 754, third party protection server 714, of which it is assumed here that it saves data about site 708 in a database updated by a content search robot and/or manually, returns a data file.

In the case of a site on which an administrative form can be filed, the file called “commercial” includes at least information allowing to detect a form filing or the preparation to file a form. In an exemplary embodiment, the file transmitted by server 714 upon request (identifying the visited site, for instance by its domain name) of terminal 712 includes at least one of the following information items:

a page address of at least one form in which the user can input information to be filed,

an address of at least one site page where one can perform a payment by giving an identification of a payment means (for example a credit cart number or an agreement for automatic payment),

an address or a domain name of at least one payment site page, for instance, bank site, on which one is directed by site 708 when one wishes to pay,

an address or a domain name of at least one page that one reaches when one wants to provide a signature or a user's authentication,

an address or a domain name of at least one server or one site on which the declaration can be continued (for instance in case of information request when site 708 uses several servers or domain names) and

keywords indicating a form filing on site 708.

Moreover, the file transmitted by server 714 can include at least one address of site 708 information page (for example, directions for filing the administrative form) and a certified date and hour and a domain name or page address on a site on which the form filing can be continued or where can be found information related to the form (laws and legal publications, for instance).

The file transmitted by server 714 may also include other information concerning sites 708 (delay for answering phone calls or e-mail, e-mail addresses to ask questions or file a complaint), information on user's protection laws applicable to forms filed on site 708 and information independent of site 708 (advice to file a form online, advertisement, access to user's protection site). The information received from third party protection site 714 is stored in terminal 712 in a file called “commercial” which is dated.

It is assumed here that the user of terminal 712 decides to perform or prepare the filing of a form on site 708.

During step 756, terminal 712 detects the filing, either when one of the addresses, one of the domain names or a keyword in the page description (for example in format HTML or XML) is identified as indicating the form filing, by comparison with the content of the commercial file corresponding to site 708 or by comparison with predetermined keywords identfying a form filing stored in terminal 712, or when the assistance software detects information to be protected (for instance keyboard input of terminal 712) which are data indicating a form filing (for instance credit card number, name or address) predetermined (for example given by the user during the assistance software installation and stored under encrypted form), or also when the use of a routine or of a software indicates a form filing (for example, transaction data storage software known under the name of “wallet”, driver of memory card reader or crypto API used during a step of authenticating or electronically signing).

During step 758, terminal 712 performs a new request to third party protection server 714 giving an identifier of site 708 to receive, in return, information which can be useful for the assistance software or for the user of terminal 712. For instance, the file transmitted by server 714 includes:

at least one address of a page of site 708 having a legal content (directions for filing the form),

one certified date and hour,

other information concerning site 708 (delay for answering phone calls or e-mail, e-mail address to get information), information on users protection laws applicable to the form filing in process on site 708 and information independent from site 708 (advice for filing a form online, advertisement, access to users protection site).

During step 760, the assistance software downloads each page of the directions of site 708 and incorporates it in the transaction file. As a variant, during step 762, server 714 downloads each direction page of site 708 and associates them to the request received from user terminal 714 with, for example, the date, hour and an user identifier.

As an option, during step 764, the assistance software displays on the screen of terminal 712 all or part of information that can be useful to the user, including under the form of links giving access to the pages stored by server 714 or buttons allowing access to details (access to applicable laws, to the site's policy, to advice, to service offers).

During step 766, the user goes on with the transaction, for example, by paying on line on site 708 or on a payment site identified in the commercial file. During a step 768, the user ends the transaction by gaining access to site 710 which is not identified in the commercial file as related to site 708.

During step 770, the assistance software associates to the transaction files, possibly completed by each direction page of site 708, a certified date and hour (received from server 714 or due to a new request of this server).

During step 772, the assistance software determines an integrity certificate (for e.g., a hash value, a redundancy code or a checksum) of the transaction file, this certificate allowing detection of any further modification of the transaction file, and stores this integrity certificate with the transaction file and the certified date and hour, the whole being called “digital contract”.

During step 774, the assistance software sends the integrity certificate to the third party protection server 714 which stores it with the certified date (for example obtained by request from three sites providing such a date) and possibly an identifier of the concerned site 708.

During step 776, the assistance software starts a storage, in a filed called “transaction file”, of information related to the communication sessions with sites 710 as indicated above and queries the third party protection site 714 by a request identifying site 710. During step 778, the third party protection server 714, of which it is assumed here that it doesn't keep data about site 710, returns a data file allowing the possible detection of a transaction.

In an exemplary embodiment, the file transmitted by server 714 upon request (identifying the visited site, for instance by its domain name) of terminal 712 includes at least one of the following information items:

a page address or a domain name of a site on which a transaction can be continued (for example, bank site receiving the payment of several merchant sites),

one keyword liable to identify a transaction.

All or part of this information is included in a dated file called “bank file”. For example, the files of the pages or domain names concerning the main banks receiving online payments in the country or the region of site 710, this country or region being determined either by the extension or ending of the domain name, or from a query to a domain name server.

It is assumed here that the user of terminal 712 decides to performs or prepare a transaction on site 710, for example by selecting a product and putting it in the shopping cart or by sending an order.

During a step 780, the terminal 712 detects the transaction, either when one of the addresses, one of the domain names or one keyword in the description of the page (for example, in format HTML or XML) is identified as indicating a transaction when compared with the content of the files corresponding to site 710 or by comparison with predetermined keywords indicating transaction stored in terminal 712 or when the assistance software detects information to be protected (for example keyboard inputs on terminal 712) which are predetermined transaction indicating data (for example credit card number, for example given when the user installs the assistance software and stored in a encrypted way), or again when the use of a routine or of a software indicates a transaction (for example, transaction data storage software known under the name of “wallet”, driver of memory card reader or crypto API used during a step of authentication or asymmetric keys electronic signature).

As a variant, a transaction is detected when a secured communication protocol is implemented, for example the encryption protocol SSL indicated by the https addresses of pages or when, in sequence, this protocol is implemented then one of the criteria indicated in step 780, is met.

During step 782, terminal 712 performs a new request to the third party protection server 714, providing it with an identifier of site 710 to receive, in return, information which can be useful for the assistance software or for the user of terminal 712. For instance, the file transmitted by server 714 includes:

one certified date and hour,

other information about consumer protection laws applying to transactions on site 710 and information independent from sites 710 (advice for online buyers, access to at least one best price search engine, advertisement, access to consumer protection site).

As a variant, during step 784, server 714 saves the request from user terminal 712 with, for instance, the date, the hour and one user identifier.

As an option, during step 786, the assistance software displays on terminal screen 712 all or part of information that can be useful for the user, including under the form of links giving access to the pages stored by server 714 or buttons allowing access to details (access to applicable laws, to the site practice, to advice, to service offers).

During step 788, the user goes on with the transaction, for example, by paying online on site 710. During a step 790, the user ends the transaction by returning on site 700.

During step 792, the assistance software includes in the transaction files a certified date and hour (already received from server 714 or thanks to a new request sent to this server).

During step 794, the assistance software determines an integrity certificate (for example a hash value, a redundancy code or a checksum) of the transaction file, this certificate allowing detection of any further modification of the transaction file, and stores this integrity certificate with the transaction file and the certified date and hour, the whole being called “digital contract”.

During step 796, the assistance software sends the integrity certificate to third party protection server 714 which stores it with the certified date (for example obtained by request from three sites providing such a date) and possibly an identifier of site 710.

One notices that, during the new communication with site 700, the first request to server 714 is inhibited by terminal 712 for a predetermined time duration or until a predetermined date depending on the date of first download of the commercial files corresponding to site 700. For instance, during one week or until the next Friday, following the first visit to site 700, the visits of sites 700 don't trigger new request from terminal 712, unless a transaction is detected.

The user can setup the assistance software in such a way that at the end of each transaction, the assistance software proposes the user to send a copy of the digital contract to the trusted third party server 716 or automatically performs this transmission.

One observes that the behavior of the assistance software describes above facing FIG. 5 is entirely automatic, the user only choosing which site he wishes to visit, selecting a product or service, ordering, filing an administrative form . . . .

One observes that it is not necessary that an integrity certificate of the digital contract be stored by the third party protection server 714 to allow the detection of any further modification of this contract. For example, as a variant, this integrity certificate is encrypted by server 714 using a public key in compliance with public key infrastructure (PKI), or by a unique universal transaction number for each transaction, and the result is associated to the digital contract stored in terminal 712.

According to an aspect of the present invention, when an online transaction is detected, for example as indicated above, or at the exit from the site on which the transaction has been detected or from any associated site, at least one reminder time period is determined, for example according to the type of transaction performed on the site and to the laws applicable to the transactions. For each reminder, when this time period is over, a question message is sent to the user and displayed on his terminal for example as a window opened on the screen of the terminal and the user chooses an answer to the question which is automatically processed according to the answer, at least one of the answers causing the transmissions of a message representing the answer to a site, for example as an access to a site page or an e-mail. According to particular features, at least one of the answers causes immediately or after other user's answers to other questions automatically asked by terminal 712 or site 714, the transmission of the recording corresponding to the detected transaction to said site receiving a message representing the answer.

FIG. 6 represents information communications between several terminals of computer servers, for the implementation of an exemplary embodiment of the present invention.

On the first line, on top of FIG. 6, are given the names and functions supported by these terminals or servers. In order, from left to right:

servers of sites 800 to 810,

a user terminal,

a portal third party protection server 814,

a trusted third party server 816.

The user terminal 812 is here either a computer or a terminal with little memory, when compared to a computer (for instance, a mobile phone or a digital assistant). The portal server 714 is used by a user terminal 812 to reach remote computer sites.

A portion of the assistance software is installed permanently on portal server 814 and reads the addresses (URL) of the visited sites, for example by reading them upon each request of a user terminal 812. When a communication between the terminal and the site is established, another portion of the assistance software monitors the information entered on terminal 812, for example on a tactile screen, to compare them to information to be protected indicating transactions (for example credit card number), keywords and/or routines and software involved (for example, transaction data storage software known under the name of “wallet”, driver of memory card reader or crypto API used during a step of authentication or electronic signature). The storage performed below is both compressed, in particular when it concerns a succession of images of the terminal display, and encrypted. For images compression, it is better to reduce the number of colours to be rendered and the number of screen shots (for example one to two per second).

During communication 820, the user terminal 812 opens a communication session with server site 800. During step 822, a portion of the assistance software implemented by portal server 814 starts a storage, in file called “transaction file”, of information related to the communication session as indicated on FIG. 5, step 722, and queries the database stored by the portal server, in a request identifying site 800. During step 824, the database of the portal server 814, which is here assumed to store the data related to site 800 being updated by a content search robot and/or by manual inspection, returns a data file. This data file includes at least information allowing detecting a transaction or the preparation of a transaction. In an exemplary embodiment, the file sent by the database of portal server 814 upon internal request (identifying the visited site for example by its domain name) includes at least one of the following information items:

an address of at least one shopping cart page of site 800 which is displayed when one selects a product or service (when using a “cart” or “shopping cart”),

an address of at least one order page of site 800 displayed when one performs an order or a purchase (“checkout” or “one-click”),

an address of at least one site page where one can perform a payment by giving an identification of a payment means (for example a credit cart number),

an address or a domain name of at least one payment site page, for instance, bank site, on which one is directed by site 800 when one wishes to pay,

an address or a domain name of at least one page that one reaches when one wants to give a signature or a buyers authentication and

an address or a domain name of at least one server or site on which the transaction can proceed (for example in case of credit request, when the site 800 uses several servers or domain names or when site 800 is associated with shopping mall in which the customer can perform multisite transactions),

one keyword indicating transaction on site 800 or a type of transaction on site 800 allowing terminal 812 to identify such keywords.

In an exemplary embodiment shown in FIG. 6, the file transmitted by the database includes an address or a domain name of at least one server or site on which the transaction can be continued (for example in case of credit request, when the site 700 uses several servers or domain names or when site 700 is associated with a shopping mall in which the customer can perform multisite transactions) if such a site exists.

Besides, the file sent by the database of portal server 814 can include at least one address of a page of site 800 which has a legal content (general sales conditions) and a certified date and hour.

This file can also include other information concerning site 800 (satisfaction rate of previous users, delays for answering phone calls or e-mail, country or state location, consumer service e-mail address, competing sites, transaction types . . . ), information about consumer protection laws applicable to transactions on site 800 and information independent from sites 800 (advice for online buyers, access to at least one best price search engine, advertisement, access to consumer protection site). Information received from the database of portal server 814 is stored by portal server 814 corresponding to an identifier of terminal 812, in a dated “commercial” file.

During a step 825, user terminal 812 ends the communication session with site 800 when no transaction or product or service selection has been detected and opens a communication session with a site 802 which is not identified in the commercial file as a site on which a transaction started on site 800 can be continued. Terminal 814 deletes the transaction file concerning site 800.

During a step 826, a portion of the assistance software implemented by portal server 814 starts a storage in a “transaction” file of information relating to the communication session, as indicated above, and queries the database of portal server 814, by a request identifying site 802. During step 828, the database of the portal server 814, which is assumed here to store data related to site 802, returns a file as indicated during step 824 and all or part of this information is included in a dated “commercial” file.

One assumed here that site 802 uses several servers, several domain names or that a transaction can be continued on several sites which are identified in the commercial file corresponding to site 802. For example, the transaction is continued on a server or site 804. In that case, during a step 830, the portion of the assistance software of portal server 814 recognizes the address or domain name concerned, doesn't stop the generation of a transaction file related to site 802 but, to the contrary, complements it during the visit of site 804.

It is assumed here that the user of terminal 812 decides to perform or prepare a transaction on site 804, for example by selecting a product and putting it in the shopping cart or by sending an order.

During step 832, the assistance software detects the transaction, as indicated on FIG. 5, step 732.

During step 834, the portal-server 814 then performs a new request to its database, giving it an identifier of site 802 or site 804 to receive, in return, information which can be useful for the assistance software or for the user of terminal 812. For instance, the file transmitted by the database may include at least one address of a page of site 802 and/or 804 which has a legal content (general sales conditions), other information concerning site 802 and/or site 804 (satisfaction rate of previous users, delay for answering phone calls or e-mail, country or state location, consumer service e-mail address, competing sites, transaction types . . . ), information about consumer protection laws applying to transactions on site 802 or 804 and/or information independent from sites 802 and 804 (certified date and hour, advice for online buyers, access to at least one best price search engine, advertisement, access to consumer protection site).

During step 836, the portion of the assistance software which is on the portal-server 814 downloads each page having a legal content of site 802 and/or site 804 and includes it in the transaction file and gives it a date, an hour, and/or a user or terminal user 812 identifier.

As an option, during step 840, the two portions of the assistance software cooperate to display on terminal screen 812 all or part of information that can be useful for the user, including under the form of links giving access to the pages stored by server 814 or buttons allowing access to details (access to applicable laws, to the site practice, to advice, to service offers).

During step 842, the user continues the transaction, for instance, by paying online on site 804 or on a payment site 806 identified in the commercial file. During a step 844, the user ends the transaction by gaining access to site 810 which is not identified in the commercial file as relating to one of the site 802 or 804.

During step 846, the portion of the assistance software which is on the portal server 814 associates to the transaction files a date, an identifier of site 802 or 804 and a certified hour.

During step 848, the assistance software determines an integrity certificate (hash value or checksum, CRC or redundancy code) of the transaction file, this certificate allowing the detection of any later modification of the transaction file, and stores this integrity certificate with the transaction file and the certified date and hour, the whole being called “digital contract”.

During step 876, the portion of the assistance software of the portal-server 814 starts a storage in a transaction file, of information related to the communication session with site 810, as indicated above and queries the database of the portal server 814 by a request identifying site 810.

During step 878, the database, about which it is supposed here that it doesn't store data relating to site 810, returns a data file liable to allow the detection of a transaction. In an exemplary embodiment, the file returned by the database upon internal request (identifying the visited site for example by its domain name) includes at least one of the following information items:

a page address or a domain name of a site on which a transaction started on site 810 is liable to proceed (for example a bank site receiving the payment of several merchant sites),

a keyword liable to identify a transaction.

All or part of this information is included in a dated file called “bank file”. For example, the files of the pages or domain names concerning the main financial companies providing online payments in the country or the region of site 810, this country or region being determined either by the extension or ending of the domain name, or from a query to a domain name server.

It is assumed here that the user of terminal 812 decides to performs or prepare a transaction on site 810, for example by selecting a product and putting it in the shopping cart or by sending an order.

During a step 880, the assistance software detects the transaction as indicated above.

In a variant, a transaction is detected when a secured communication protocol is used, for example the SSL encryption protocol indicated by the https addresses of pages or when, in sequence, this protocol is implemented and then one of the criteria indicated in step 880, is met.

During step 882, portal server 814 performs a new request to its database giving an identifier of site 810 to receive, in return, information which can be useful for the assistance software or for the user of terminal 812. For instance, the file transmitted by server 814 may include information concerning consumer protection laws applying to the transaction in process on site 810 (certified date and hour, advice for online buyers, access to at least one best price search engine, advertisement, access to consumer protection site).

As an option, during step 886, the two portions of the assistance software cooperate to display on terminal screen 812 all or part of information that can be useful for the user, including under the form of links giving access to the pages stored by portal server 814 or buttons allowing access to details (access to applicable laws, to the site practice, to advice, to service offers).

During step 888, the user continues the transaction, for instance, by paying on line on site 810 or on a site indicated by the database in answer of the first request. During a step 890, the user ends the transaction by returning on site 800.

During step 892, the assistance software associates to the transaction files a certified date and hour (requested from dedicated servers).

During step 894, the assistance software determines an integrity certificate of the transaction in such a way that any further modification of the transaction file may be detected and stores this integrity certificate on portal server 814 with the transaction files and the associate data, the whole being called “digital contract”.

The user can setup the assistance software in such a way that, at the end of each detected transaction, the assistance software either proposes to the user to send a copy of the digital contract to the trusted third party server 816 or automatically performs this transmission.

One observes that the behavior of the assistance software described above, facing FIG. 6, is entirely automatic, the only user action is limited to choose which site he wishes to visit, to select a product or service, to order, to perform an administrative declaration . . . .

Although the description presents mainly interaction in network under the form of site pages visits, the present invention applies as well to transactions performed by phone on internet. For example, the start of a software or of a routine of phone call or detection of a site page allowing activating this phone call can be used to detect transaction, the recording then including information representing phone call, e.g. sound file.

Likewise, the recording can, in a variant, include files representing sounds when the remote site sends them, for example in pages description.

One observes that the man skilled in the art knows how to get the address and the domain name of a visited page either by using the browsing software or by scanning the information transiting through port 443 or port 80 (“com” port), or else by implementing a software known as “proxy”.

The aspect of the invention shown in FIG. 7 (in relation diagram in FIG. 7A and in organigram in FIG. 7B) concerns a contextual offer providing method characterized by:

a step of communicating between a user terminal and a remote site,

a step of detecting, on at least one page of said remote site, at least one of the following information items:

an address of said visited remote site,

domain name of said remote site,

a keyword,

a step of searching, in a database, at least one page address or a domain name of a third party site called “partner”, independent from said remote site and

a step of displaying at least one link to the third party site page address or to the domain name of said third party site.

Other advantages, aims and features of this aspect will show up from the description made with regards to FIG. 7.

In an exemplary embodiment of this aspect of the present invention, which is independent from the other aspects shown above but can be combined to them and uses techniques, means and steps presented above with regards to FIGS. 1 to 6, a third party protection site 914 stores in a database of offers of a search engine, page addresses or domain names of partner site 910 and, for each address or domain name of a partner site, one at least of the following information items:

at least one page address or domain name of a site 908 of a competitor of said partner site 910 and/or

a keyword to be searched in the page content of remote sites 908 visited by the user through terminal 912.

Preferably, the database of offers of the search engine also includes, for each partner site 910 or for each page address of partner site 910, one at least of the following information items:

the price of a product or service sold on said site 910 or on said page of site 910 respectively,

preferably, a feature of said product or service (for instance: reference, first hand, second hand, refurbished, by lots, offers reserved to certain customers, availability).

In the embodiment shown in FIG. 7, the assistance software which can be installed on the user terminal 912 or on a server 906 to which terminal 912 can gain access in order to reach remotes sites 908, step 950, monitors the names or page addresses or keywords on the visited remote sites 908, which are not necessarily partner sites 910 but are referred to facing domain names or page addresses of at least one partner site 910 in the database of the search engine, by performing, during step 952, a monitoring as explained in FIGS. 1 to 6, for instance facing step 732. For example, as soon as the terminal 100 receives a page relating to a monitored domain name, relating to a monitored page address or including a monitored keyword, the assistance software detects, during step 954, the possibility to make an offer from a partner site 910, as a detection of a remote site 908 offer.

When the possibility to make an offer from a partner site is determined during step 954, during step 956, the assistance software opens or gives access to a window on the screen of terminal 912 to display (related to at least one domain name of the partner site 910 and each page of the partner site 910 which, in the database of offers of the search engine, is associated to the visited page of the remote site 908) at least one of the following information items:

a link to said partner site 910,

a link to the page of said partner site 910,

the price offered by the partner site for each product or service associated to the domain name or the page of the partner site and

a feature of the product or service associated to the domain name or the page of the partner site.

Preferably, if remote site 908 is a partner site 910, its own offer(s) are not displayed. In an exemplary embodiment, only the information concerning the partner site, or several partner sites, offering the best price, or the several best prices, for each offer parameter, is displayed.

This way, the assistance software provides, in addition or instead of protection shown in FIGS. 1 to 6, an assistance to the transaction by providing contextual competitors' offers. For instance, the database of offers of the search engine includes:

1/in relation with the address www.amazon.fr/olympus/OM10.htm, the following data:

www.nomatica.com,

www.fnac.com/photo/olympus.htm,

Olympus,

second hand,

1350 euros.

2/in relation with the address www.photopro.fr, the following data:

www.fnac.com/photo/olympus.htm,

Olympus OM10,

second hand,

1250 euros.

3/in relation with the address www.videoshop.fr/photonumericque.htm, the following data:

www.nomatica.com,

www.fnac.com/photo/olympus.htm,

Olympus OM9,

brand new,

2550 euros.

When the user of terminal 912 gains access to the page www.fnac.com/photo/olympus.htm, the window opened on the screen of its terminal includes:

Brand new:

Olympus OM9, 2550 euros, www.videoshop.fr/photonumericque.htm

Second hand:

Olympus OM 10, 1250 euros, www.photopro.fr

Olympus, 1350 euros, www.amazon.fr/olympus/OM10.htm and one link is attached to www.videoshop.fr/photonumericque.htm, www.photopro.fr and www.amazon.fr/olympus/OM10.htm in such a way that the user be able to review these offers on the partners' sites or on the pages of partners' sites 910 in question, during step 958. If the detection of an offer of remote site 908 doesn't take place during step 954, or at the end of step 958, step 950 is rerun.

One observes that the display may be a window or an icon in the toolbar which blinks when an offer of the partner site exists and when the user clicks on this icon, the display of a window that includes each offer of third party sites.

One observes that, for the implementation of this aspect of the invention, the assistance software can, according to two variants represented in FIG. 7B by steps framed in broken lines:

send to the search engine database, a query giving the names of the visited sites, the address of the visited page of the site or the keywords located in it, step 951, at each change of page, or

search a database updated from the database of the third party protection site 914, which can be stored and updated, in relation with the third party protection site 914, in terminal 912 or in server 906 implementing the assistance software, step 948.

1. A transaction information backup method including:
a step of detecting a start of a visit of a remote site,
a step of detecting a transaction including at least one of the following steps:
a step of detecting an implementation of an authentication method or an asymmetric keys electronic signature of the user,
a step of detecting at least one predetermined symbol sequence in a page received from the site and
a step of determining that a page address or a domain name of the remote site corresponds to at least one predetermined address;
and when a transaction is detected, a step of storing in permanent memory a trace of pages of said remote site.
